(19) United States
(12) Patent Application Publication
(10) Pub. No.: US 2025/0106873 A1
(43) Pub. Date: Mar. 27, 2025

(54) METHOD AND DEVICE FOR TRANSMITTING SIDELINK POSITIONING REFERENCE SIGNAL IN WIRELESS COMMUNICATION SYSTEM

(71) Applicant: Samsung Electronics Co., Ltd., Gyeonggi-do (KR)

(72) Inventors: Jeongseok YU, Gyeonggi-do (KR); Hyunjeong KANG, Gyeonggi-do (KR); Taeseop LEE, Gyeonggi-do (KR)

(21) Appl. No.: 18/899,008

(22) Filed: Sep. 27, 2024

(30) Foreign Application Priority Data
Sep. 27, 2023 (KR) 10-2023-0131083

(51) Int. Cl. H04W 72/25; H04L 1/1812; H04L 5/00; H04W 72/566

(52) U.S. Cl. CPC H04W 72/25; H04L 1/1812; H04L 5/0051; H04W 72/566

(57) ABSTRACT

The disclosure relates to a 5G or 6G communication system for supporting a higher data transmission rate. A method performed by a terminal for SL communication is provided, which includes receiving, from a base station, an SL grant for SL transmission; in case that there is an SL-PRS for transmission for a selected destination, identifying a first TBS including the SL-PRS based on the SL grant; and in case that all data within a logical channel with higher priority than a logical channel of the SL-PRS is allocated with resources of the SL grant, transmitting the SL-PRS based on the SL grant.

### CROSS-REFERENCE TO RELATED APPLICATION(S)

This application is based on and claims priority under 35 U.S.C. § 119 to Korean Patent Application No. 10-2023-0131083, filed on Sep. 27, 2023, in the Korean Intellectual Property Office, the entire disclosure of which is incorporated herein by reference.

### BACKGROUND

### 1. Field

The disclosure relates generally to a wireless communication system and, more particularly, to a method and a device for transmitting a sidelink positioning reference signal (SL-PRS) in a wireless communication system.

### 2. Description of Related Art

Fifth generation (5G) mobile communication technologies define broad frequency bands to enable high transmission rates and new services, and can be implemented not only in sub 6 gigahertz (GHz) bands such as 3.5 GHz, but also in above 6 GHz bands referred to as millimeter wave (mm Wave) bands including 28 GHz and 39 GHz bands. In addition, it has been considered to implement sixth generation (6G) mobile communication technologies referred to as beyond 5G systems in terahertz (THz) bands (e.g., 95 GHz to 3 THz bands) to realize transmission rates fifty times faster than 5G mobile communication technologies and ultra-low latencies one-tenth of 5G mobile communication technologies.

Since the initial stage of 5G mobile communication technologies, to support services and to satisfy performance requirements in connection with enhanced mobile broadband (eMBB), ultra reliable & low latency communications (URLLC), and massive machine-type communications (mMTC), there has been ongoing standardization regarding beamforming and massive multiple input multiple output (MIMO) for alleviating radio-wave path loss and increasing radio-wave transmission distances in mmWave, numerology (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network customized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for securing coverage in an area in which communication with terrestrial networks is unavailable, and positioning.

There is also ongoing standardization in wireless interface architecture/protocol fields regarding technologies such as industrial Internet of things (IIOT) for supporting new services through interworking and convergence with other industries, integrated access and backhaul IAB) for providing a node for network service area expansion by supporting a wireless backhaul link and an access link in an integrated manner, mobility enhancement including conditional handover and dual active protocol stack (DAPS) handover, and two-step random access for simplifying two-step random access channel (2-step RACH) procedures for NR. There also has been ongoing standardization in system architecture/service fields regarding a 5G baseline architecture (e.g., service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for securing coverage in terahertz bands of 6G mobile communication technologies, full dimensional MIMO (FD-MIMO), multi-antenna transmission technologies such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above-mentioned problems and/or disadvantages and to provide at least the advantages described below.

Accordingly, an aspect of the disclosure is to provide a method and a device for transmitting an SL-PRS in a wireless communication system, so as to more efficiently provide transmission and measurement of the SL-PRS used in a sidelink positioning procedure, and selection and allocation of sidelink transmission resources.

An aspect of the disclosure is to provide a method and a device for transmitting an SL-PRS transmittable by at least two UEs which may be within a base station communication range and/or outside the base station communication range to perform the sidelink positioning procedure in a communication system.

An aspect of the disclosure is to provide, when transmitting an SL-PRS, a terminal to perform the sidelink positioning procedure by comparing the priority of the SL-PRS with the priority of SL data, to efficiently select resources for transmitting the SL-PRS, and to allocate resources of the SL data accordingly.

In accordance with an aspect of the disclosure, a method performed by a terminal for SL communication includes receiving, from a base station, an SL grant for SL transmission, in case that there is an SL-PRS for transmission for a selected destination, identifying a first transport block size (TBS) including the SL-PRS based on the SL grant, and in case that all data within a logical channel with higher priority than a logical channel of the SL-PRS is allocated with resources of the SL grant, transmitting the SL-PRS based on the SL grant.

In accordance with an aspect of the disclosure, a terminal for SL communication includes a transceiver, and a controller coupled with the transceiver and configured to receive, from a base station, an SL grant for SL transmission, in case that there is SL-PRS for transmission for a selected destination, identify a first TBS including the SL-PRS based on the SL grant, and in case that all data within a logical channel with higher priority than a logical channel of the SL-PRS is allocated with resources of the SL grant, transmit the SL-PRS based on the SL grant.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a next-generation mobile communication system according to an embodiment;

FIG. 2 illustrates a user plane radio protocol structure of a next-generation mobile communication system according to an embodiment;

FIG. 3 illustrates a control plane radio protocol structure of a next-generation mobile communication system according to an embodiment;

FIG. 4 illustrates a structure of a base station in a wireless communication system according to an embodiment;

FIG. 5 illustrates a structure of a UE in a wireless communication system according to an embodiment;

FIG. 6A illustrates examples of scenarios for SL communication in the wireless communication system according to an embodiment;

FIG. 6B illustrates examples of scenarios for SL communication in the wireless communication system according to an embodiment;

FIG. 6C illustrates examples of scenarios for SL communication in the wireless communication system according to an embodiment;

FIG. 6D illustrates examples of scenarios for SL communication in the wireless communication system according to an embodiment;

FIG. 7A illustrates examples of a transmission scheme for SL communication in the wireless communication system according to an embodiment;

FIG. 7B illustrates examples of a transmission scheme for SL communication in the wireless communication system according to an embodiment;

FIG. 8 illustrates an example of an SL resource pool in the wireless communication system according to an embodiment;

FIG. 9 illustrates an example of a signal flow for allocating transmission resources of an SL in the wireless communication system according to an embodiment;

FIG. 10 illustrates another example of a signal flow for allocating transmission resources of an SL in the wireless communication system according to an embodiment;

FIG. 11A illustrates an example of a channel structure of a slot used for SL communication in the wireless communication system according to an embodiment;

FIG. 11B illustrates an example of a channel structure of a slot used for SL communication and for a SL-PRS in the wireless communication system according to an embodiment;

FIG. 12 illustrates a procedure for a transmission UE to transmit SL data in the wireless communication system according to an embodiment;

FIG. 13 illustrates a procedure for a transmission UE to transmit SL data and an SL-PRS in the wireless communication system according to an embodiment;

FIG. 14 illustrates a procedure for a transmission UE to transmit SL data and an SL-PRS in the wireless communication system according to an embodiment; and

FIG. 15 illustrates a procedure for a transmission UE to transmit an SL-PRS in the wireless communication system according to various embodiments of the disclosure.

### DETAILED DESCRIPTION

Hereinafter, embodiments of the disclosure will be described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some elements may be exaggerated, omitted, or schematically illustrated. The size of each element does not completely reflect the actual size. In the respective drawings, the same or corresponding elements are assigned the same reference numerals.

The disclosure is not limited to the embodiments set forth below, but may be implemented in various different forms. The following embodiments are provided only to completely disclose the disclosure and inform those skilled in the art of the scope of the disclosure. Throughout the specification, the same or like reference signs indicate the same or like elements.

Herein, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The following description is mainly directed to NR as a radio access network (RAN) and packet core as a core network (CN) in the 5G mobile communication standards specified by the 3rd generation partnership project (3GPP) that is a mobile communication standardization group. However, based on determinations by those skilled in the art, the disclosure may be applied to other communication systems having similar backgrounds through some modifications without significantly departing from the scope of the disclosure.

Some of terms and names defined in the 3GPP standards may be used herein for the sake of descriptive convenience. However, the disclosure is not limited by these terms and names, and may be similarly applied to systems that conform other standards.

Herein, terms for identifying access nodes and referring to network entities, messages, interfaces between network entities, various identification information, and the like are illustratively used for the sake of descriptive convenience. Therefore, the disclosure is not limited by the terms as used herein, and other terms referring to subjects having equivalent technical meanings may be used.

Herein, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a downlink (DL) refers to a radio link via which a base station transmits a signal to a terminal, and an uplink (UL) refers to a radio link via which a terminal transmits a signal to a base station.

A UE may refer to a vehicle supporting vehicle-to-vehicle (V2V) communication, a pedestrian handset (e.g., a smartphone) or a vehicle supporting vehicle-to-pedestrian (V2P) communication, a vehicle supporting vehicle-to-network (V2N) communication, or a vehicle supporting vehicle-to-infrastructure (V2I) communication. A UE may also refer to a road side unit (RSU) equipped with UE functions, an RSU equipped with base station functions, or an RSU equipped with some of the BS functions and some of the UE functions. In addition, a UE may refer to a UE supporting a proximity service (hereinafter, ProSe) and an sidelink positioning procedure.

Herein, a base station may support both SL and general cellular communication, or may support only SL. In this case, the base station may be a 5G base station (gNB), a 4G base station (eNB), or an RSU.

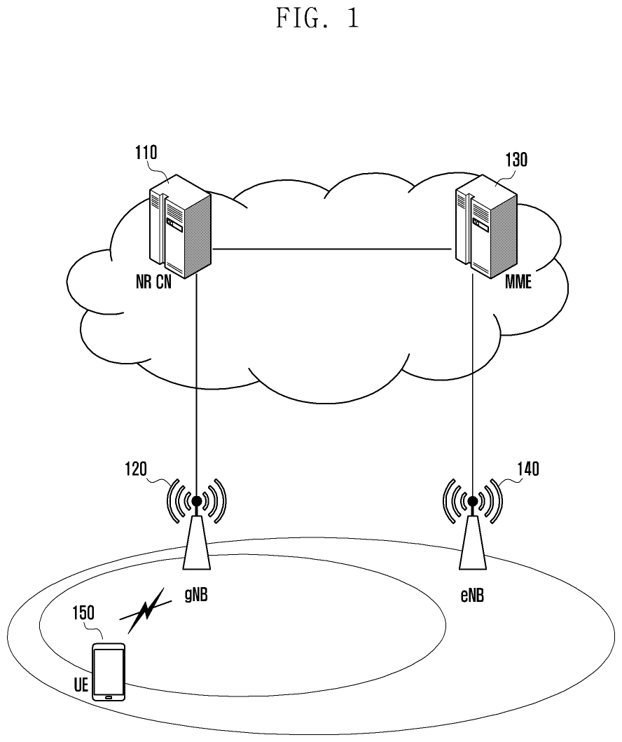

FIG. 1 illustrates a structure of a next-generation mobile communication system according to an embodiment.

Referring to FIG. 1, a radio access network of a next-generation mobile communication system (hereinafter, NR or 5G) may include a next-generation base station (a new radio (NR) node B, NR gNB, gNB, or NR base station) 120, and an (NR CN 110. A user terminal (an NR UE or an NR terminal) 150 may access an external network via the NR gNB 120 and the NR CN 110.

The NR gNB 120 may be connected to the NR UE 150 through a radio channel and provide outstanding services as compared to the eNB 140. In the next-generation mobile communication system, since all user traffic is serviced through a shared channel, a device that collects state information, such as buffer statuses, available transmit power states, and channel states of UEs, and performs scheduling accordingly is required, and the NR gNB 120 may serve as the device. In general, one NR gNB 120 may control multiple cells. To implement ultrahigh-speed data transfer beyond long term evolution (LTE), a wider bandwidth than the maximum bandwidth of LTE may be used, an orthogonal frequency division multiplexing (OFDM) scheme may be employed as a radio access technology, and a beamforming technology may be additionally integrated therewith. Furthermore, an adaptive modulation and coding (AMC) scheme for determining a modulation scheme and a channel coding rate according to a channel state of a UE may be employed. The NR CN 110 may perform functions such as mobility support and quality of service (QOS) configuration. The NR CN 110 is a device responsible for various control functions as well as a mobility management function for a UE, and may be connected to multiple base stations. The next-generation mobile communication system may interwork with the existing LTE system, and the NR CN 110 may be connected to a mobility management entity (MME) 130 via a network interface. The MME 130 may be connected to the eNB 140.

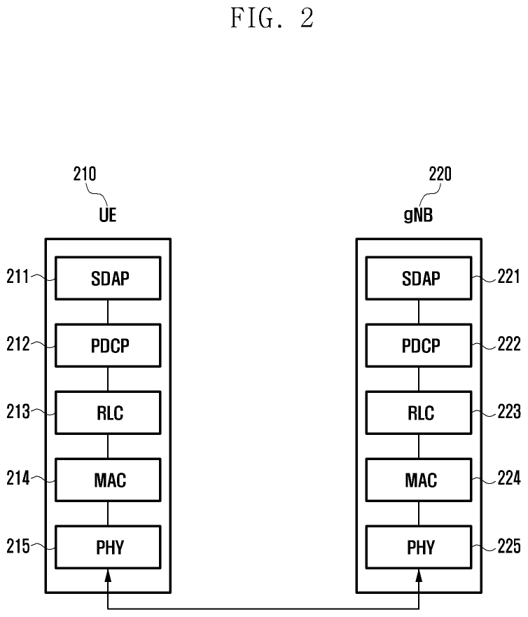

FIG. 2 illustrates a user plane radio protocol structure of a next-generation mobile communication system according to an embodiment.

Referring to FIG. 2, in a UE 210, a user plane radio protocol of a next-generation mobile communication system may consist of a service data adaptation protocol (SDAP) 211, a packet data convergence protocol (PDCP) 212, a radio link control (RLC) 213, a medium access control (MAC) 214, and/or a physical (PHY) layer 215. In a gNB 220, a user plane radio protocol of a next-generation mobile communication system may consist of an SDAP 221, a PDCP 222, an RLC 223, an MAC 224, and/or a PHY 225. For example, in a UE 210, a user plane radio protocol of a next-generation mobile communication system may include an SDAP 211, a PDCP 212, an RLC 213, an MAC 214, and/or a PHY 215.

The main functions of the SDAP 211 or 221 may include the following functions.
Mapping between a QoS flow and a data radio bearer
Marking QoS flow ID (QFI) in both DL and UL packets.
The main functions of the PDCP 212 or 222 may include the following functions.
Transfer of data (user plane or control plane)
Maintenance of PDCP sequence numbers (SNs)
Header compression and decompression using a robust header compression (ROHC) protocol
Header compression and decompression using ethernet header compression (EHC) protocol
Compression and decompression of UL PDCP service data units (SDUs): DEFLATE based uplink data compression (UDC) only
Ciphering and deciphering
Integrity protection and integrity verification)
Timer based SDU discard
For split bearers, routing
Duplication
Reordering and in-order delivery
Out-of-order delivery
Duplicate discarding
The main functions of the RLC 213 or 223 may include the following functions.
Transfer of upper layer PDUs
Sequence numbering independent of the one in PDCP (un-acknowledge mode (UM) and acknowledge mode (AM))
Error correction through automatic repeat request (ARQ) (AM only)
Segmentation (AM and UM) and re-segmentation (AM only) of RLC SDUs
Reassembly of SDU (AM and UM)
Duplicate detection (AM only)
RLC SDU discard (AM and UM)
RLC re-establishment
Protocol error detection (AM only)
The main functions of the MAC 214 or 224 may include the following functions.
Mapping between logical channels and transport channels
Multiplexing of MAC SDUs from one or different logical channels onto transport blocks (TBs) to be delivered to physical layer on transport channels
Demultiplexing of MAC SDUs to one or different logical channels from TBs delivered from physical layer on transport channels
Scheduling information reporting Error correction through hybrid automatic repeat request (HARQ)
Logical channel prioritization
Priority handling between overlapping resources of one UE

The PHY layer 215 or 225 may perform channel coding and modulation of upper layer data to generate OFDM symbols and may convert the OFDM symbols into a radio frequency (RF) signal and then transmit the same through an antenna. The PHY layer 215 or 225 may perform demodulation and channel decoding of the received OFDM symbols and then transfer the OFDM symbols to an upper layer.

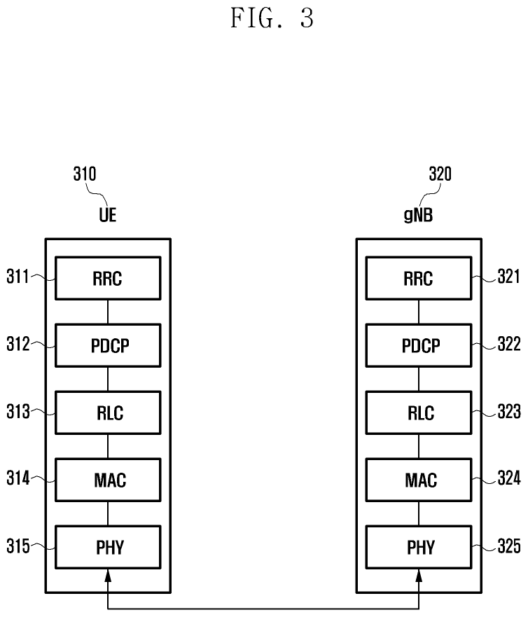

FIG. 3 illustrates a control plane radio protocol structure of a next-generation mobile communication system according to an embodiment.

Referring to FIG. 3, a control plane radio protocol of a next-generation mobile communication system may be configured by a radio resource control (RRC) 311, a PDCP 312, an RLC 313, a MAC 314, and/or a PHY 315 in a UE 310, and may be configured by an RRC 321, a PDCP 322, an RLC 323, a MAC 324, and/or a PHY 325 in a base station 320.

Functions of the RRCs 311 and 321 may include the following functions.
Broadcast of system information (related to access stratum (AS) and non-access stratum (NAS))
Paging (initiated by 5G core (5GC) or next generation (NG)-RAN)

Establishment and management of an RRC connection between a UE and an NG-RAN, and addition, modification, and release of carrier aggregation and of dual-connectivity between NRs or between evolved universal terrestrial radio access (E-UTRA) and NR (Establishment, maintenance and release of an RRC connection between the UE and NG-RAN including: addition, modification and release of carrier aggregation; addition, modification and release of dual connectivity in NR or between E-UTRA and NR.)
Security functions including key management
Establishment, configuration, maintenance, and release of signaling radio bearers (SRBs) and data radio bearers (DRBs)
UE mobility support (Mobility functions including: handover and context transfer; UE cell selection and reselection and control of cell selection and reselection; inter-RAT mobility.)
QoS management functions
UE measurement reporting and control of the reporting
Radio link failure detection and recovery (Detection of and recovery from radio link failure) NAS message transmission (NAS message transfer to/from NAS from/to UE)
Main functions of the PDCPs 312 and 322, the RLCs 313 and 323, the MACs 314 and 324, and/or the PHY 315 and 325 may follow the example of FIG. 2.

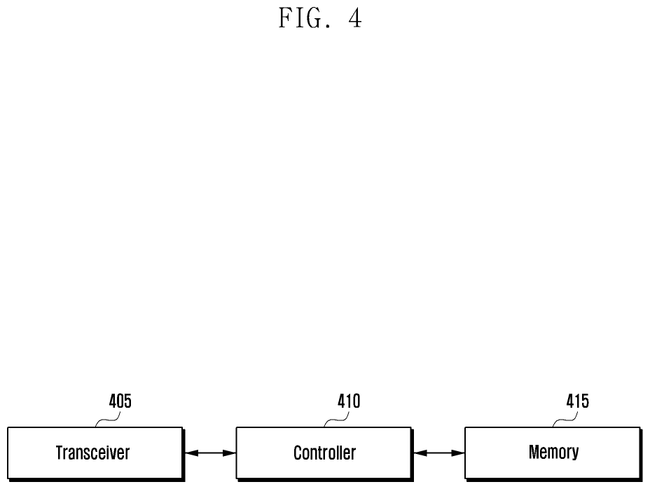

FIG. 4 illustrates a structure of a base station according to an embodiment.

Referring to FIG. 4, the base station includes a transceiver 405, a controller 410, and a memory 415, which may be operated according to the above-described communication methods of the base station. A network device may also correspond to the structure of the base station.

However, components of the base station are not limited to the above-described example. For example, the base station may include more or fewer components than the above-described components. For example, the base station may include the transceiver 405 and the controller 410. The transceiver 405, the controller 410, and the memory 415 may be implemented in the form of a single chip.

The transceiver 405 refers to a base station receiver and a base station transmitter as a whole, and may transmit/receive signals with UEs, other base stations, or other network devices. The signals may include control information and data. The transceiver 405 may transmit, for example, system information, synchronization signals, or reference signals to UEs. To this end, the transceiver 405 may include an RF transmitter configured to up-convert and amplify the frequency of transmitted signals, an RF receiver configured to low-noise-amplify received signals and down-convert the frequency thereof, and the like. However, the components of the transceiver 405 are not limited to the RF transmitter and the RF receiver. The transceiver 405 may include wired/wireless transceivers, and may include various components for transmitting/receiving signals. The transceiver 405 may receive signals through a communication channel (e.g., a radio channel), output the same to the controller 410, and transmit signals output from the controller 410 through the communication channel. The transceiver 405 may receive communication signals, output same to a processor, and transmit signals output from the processor to UEs, other base stations, or other network entities through a wired/wireless network.

The memory 415 may store programs and data necessary for operations of the base station. The memory 415 may store control information or data included in signals acquired by the base station. The memory 415 may include storage media such as a read only memory (ROM), a random access memory (RAM), a hard disk, a compact disc (CD)-ROM, and a digital versatile disc (DVD), or a combination of storage media. The memory 415 may store at least one of information transmitted/received through the transceiver 405 and information generated through the controller 410.

As used herein, the controller 410 may be defined as a circuit, an application specific integrated circuit, or at least one processor. The processor may include a communication processor (CP) which performs control for communication and an application processor (AP) which controls upper layers such as application programs. The controller 410 may control the overall operation of the base station according to the disclosure. For example, the controller 410 may control signal flows between the respective blocks to perform operations according to the above-described flowcharts.

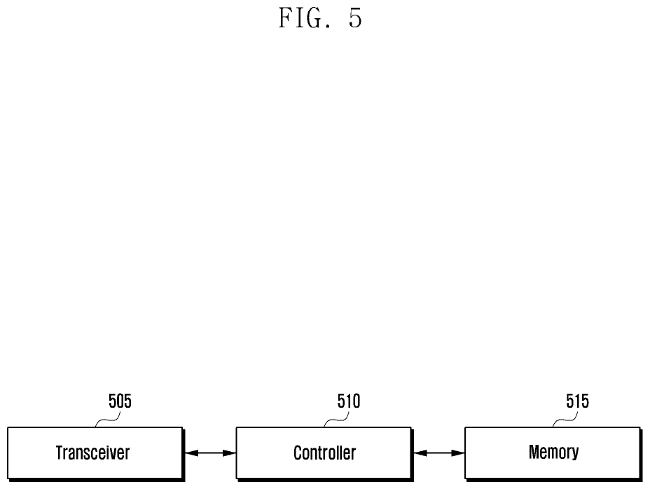

FIG. 5 illustrates a structure of a UE according to an embodiment.

Referring to FIG. 5, the UE includes a transceiver 505, a controller 510, and a memory 515. The transceiver 505, the controller 510, and the memory 515 may be operated according to the above-described communication methods of the UE. Components of the UE are not limited to the above-described example. For example, the UE may include more or fewer components than the above-described components. For example, the UE may include the transceiver 505 and the controller 510. The transceiver 505, the controller 510, and the memory 515 may be implemented in the form of a single chip.

The transceiver 505 refers to a UE receiver and a UE transmitter as a whole, and may transmit/receive signals with a base station, other UEs, or network entities. The signals may include control information and data. The transceiver 505 may receive, for example, system information, synchronization signals, or reference signals from the base station. To this end, the transceiver 505 may include an RF transmitter configured to up-convert and amplify the frequency of transmitted signals, an RF receiver configured to low-noise-amplify received signals and down-convert the frequency thereof, and the like. However, the components of the transceiver 505 are not limited to the RF transmitter and the RF receiver. Also, the transceiver 505 may include wired/wireless transceivers, and may include various components for transmitting/receiving signals. The transceiver 505 may receive signals through a radio channel, output the same to the controller 510, and transmit signals output from the controller 510 through the radio channel. The transceiver 505 may receive communication signals, output same to a processor, and transmit signals output from the processor to network entities through a wired/wireless network.

The memory 515 may store programs and data necessary for operations of the UE. The memory 515 may store control information or data included in signals acquired by the UE. The memory 515 may include storage media such as a ROM, a RAM, a hard disk, a CD-ROM, and a DVD, or a combination of storage media.

As used herein, the controller 510 may be defined as a circuit, an application specific integrated circuit, or at least one processor. The processor may include a CP which performs control for communication and an AP which controls upper layers such as application programs. The controller 510 may control the overall operation of the UE according to embodiments of the disclosure. For example, the controller 510 may control signal flows between the respective blocks to perform operations according to the above-described flowcharts.

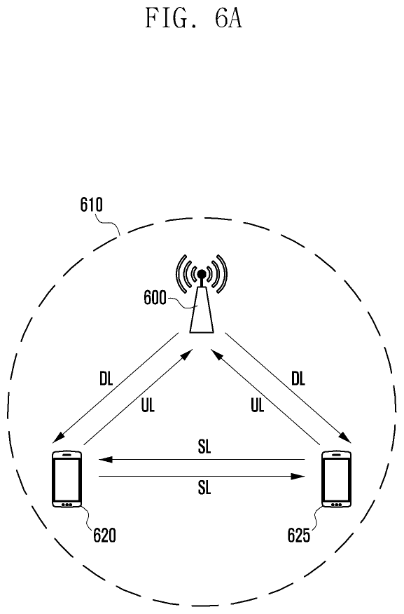

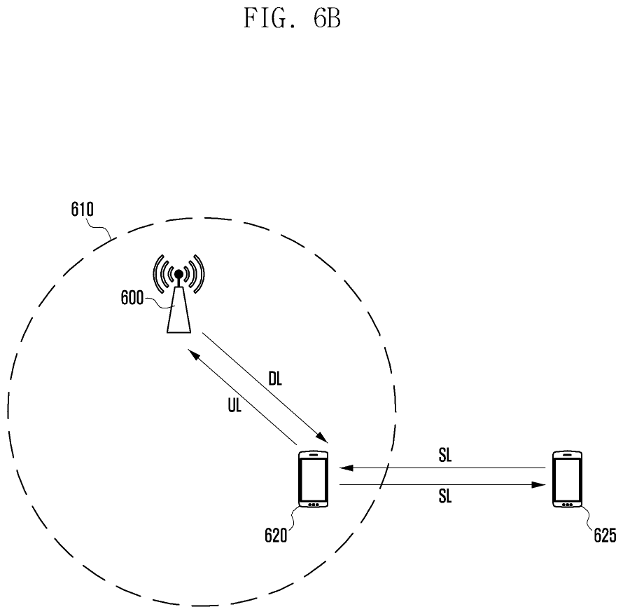

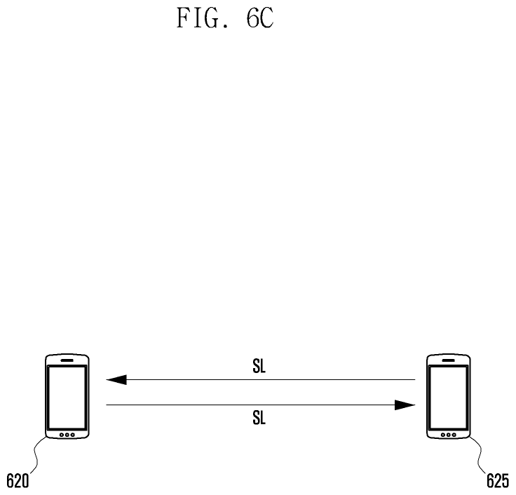

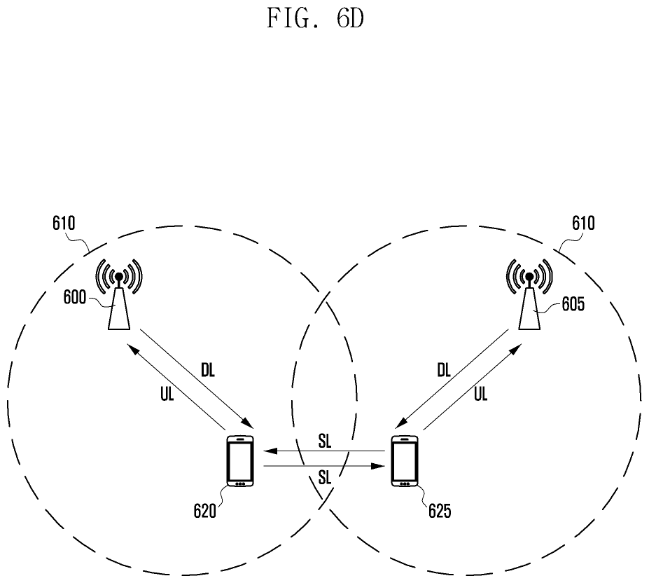

FIG. 6A illustrates examples of scenarios for SL communication in the wireless communication system according to an embodiment. FIG. 6B illustrates examples of scenarios for SL communication in the wireless communication system according to an embodiment. FIG. 6C illustrates examples of scenarios for SL communication in the wireless communication system according to an embodiment. FIG. 6D illustrates examples of scenarios for SL communication in the wireless communication system according to an embodiment.

FIG. 6A illustrates an in-coverage (IC) scenario in which SL UEs 620 and 625 are located within coverage 610 of a base station 600. The SL UEs 620 and 625 may receive data and control information from the base station via a DL, or transmit data and control information to the base station via a UL. In this case, the data and control information may be data and control information for SL communication, or data and control information for general cellular communication other than SL communication. The SL UEs 620 and 625 in FIG. 6A may transmit and receive data and control information for SL communication via an SL.

FIG. 6B illustrates a case of partial coverage (PC) in which the first UE 620 among the SL UEs is located within the coverage 610 of the base station 600 and the second UE 625 is located outside the coverage 610 of the base station 600. The first UE 620 located within the coverage 610 of the base station 600 may receive data and control information from the base station via a DL or transmit data and control information to the base station via a UL. The second UE 625 located outside the coverage of the base station 600 cannot directly receive data and control information from the base station via a DL and cannot directly transmit data and control information to the base station via a UL. The second UE 625 may transmit and receive data and control information for SL communication to and from the first UE 620 via an SL.

FIG. 6C is an example of when the SL UEs (e.g., the first UE 620 and the second UE 625) are located outside the coverage 610 (out-of-coverage (OOC)) of the base station 600. Therefore, the first UE 620 and the second UE 625 cannot receive data and control information from the base station via a DL, and cannot transmit data and control information to the base station via a UL. The first UE 620 and the second UE 625 may transmit and receive data and control information for SL communication via an SL.

FIG. 6D illustrates when the first UE 620 and the second UE 625 performing SL communication are connected (e.g., an RRC connected state) to or camping on (e.g., an RRC disconnected state, i.e., an RRC idle state or inactive state) different base stations (e.g., the first base station 600 and a second base station 605), inter-cell SL communication is performed. In this case, the first UE 620 may be an SL transmission UE and the second UE 625 may be an SL reception UE. Alternatively, the first UE 620 may be an SL reception UE and the second UE 625 may be an SL transmission UE. The first UE 620 may receive a system information block (SIB) for SL from the base station 600 to which the first UE 620 is connected (or on which the first UE 620 is camping). The second UE 625 may receive an SIB for SL from the base station 605 to which the second UE 625 is connected (or on which the second UE 625 is camping). In this case, information of the SIB for the SL, which is received by the first UE 620, and information of the SIB for the SL, which is received by the second UE 625, may be different from each other. Therefore, to perform SL communication between the UEs located in different cells, it may be necessary to unify the information or an assumption and interpretation method therefor may be additionally required.

In FIG. 6A to FIG. 6D, for convenience of description, an SL system including two UEs (e.g., the first UE 620 and the second UE 625) is exemplified, but the disclosure is not limited thereto and may be applied to an SL system involving three or more UEs. The UL and DL between the base station 600 and the SL UEs may be referred to as a Uu interface, and the SL between the SL UEs may be referred to as a PC5 interface. In addition, a SL UE located out of coverage (OOC), i.e., the SL UE located where the base station 600 and the Uu interface are not connected, may indirectly receive data and control information from the base station via a relay of a SL UE located in coverage (IC) where the base station and the Uu interface are connected. Herein, UL or DL and a Uu interface may be used interchangeably, and SL and PC5 may be used interchangeably.

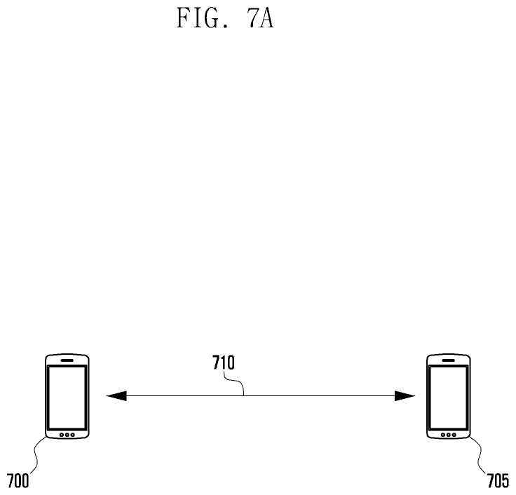

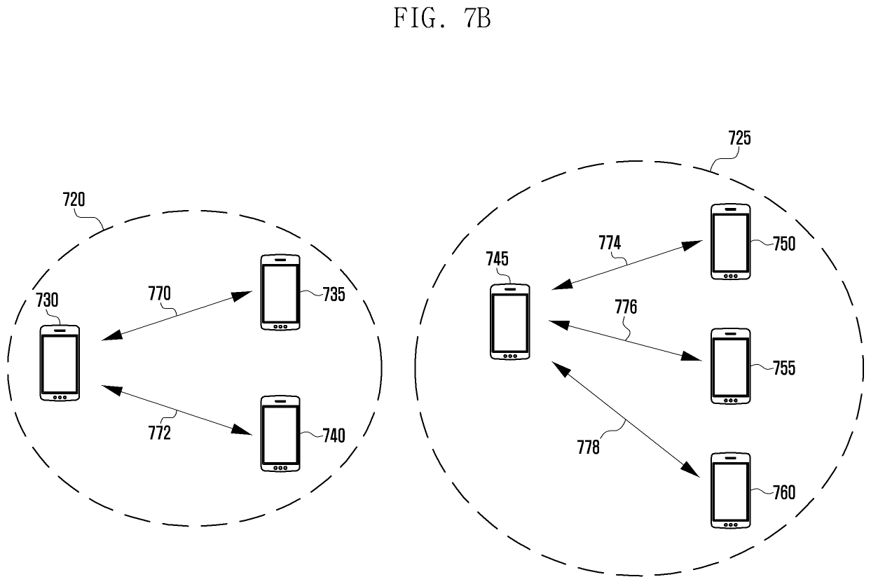

FIG. 7A illustrates examples of a transmission scheme for SL communication in the wireless communication system according to an embodiment. FIG. 7B illustrates examples of a transmission scheme for SL communication in the wireless communication system according to an embodiment. FIG. 7A illustrates a unicast scheme, and FIG. 7B illustrates a groupcast scheme.

As shown in FIG. 7A, a transmission UE 700 and a reception UE 705 may perform one-to-one communication. A transmission scheme as in FIG. 7A may be referred to as unicast communication. As shown in FIG. 7B, a transmission UE 730 or 745 and reception UEs 735, 740, 750, 755, and 760 may perform one-to-many communication. A transmission scheme as in FIG. 7B may be referred to as groupcast or multicast.

In FIG. 7B, the first UE 730, the second UE 735, and the third UE 740 may form one group and perform groupcast communication, and the fourth UE 745, the fifth UE 750, the sixth UE 755, and the seventh UE 760 may form another group and perform groupcast communication. The UEs may perform groupcast communication within the groups to which the UEs belong, and may perform unicast, groupcast, or broadcast communication with at least one other UE belonging to a different group. In FIG. 7B, two groups are shown, but the disclosure is not limited thereto and may be applied to more groups.

In FIG. 7A or FIG. 7B, SL UEs may perform broadcast communication, which refers to a scheme in which all SL UEs receive data and control information transmitted by a SL transmission UE via an SL. For example, if the first UE 730 in FIG. 7B is a transmission UE, the remaining UEs 735, 740, 745, 750, 755, and 760 may receive data and control information transmitted by the first UE 730.

The aforementioned SL unicast communication, groupcast communication, and broadcast communication may be supported in an IC scenario, a partial-coverage scenario, or an OOC scenario.

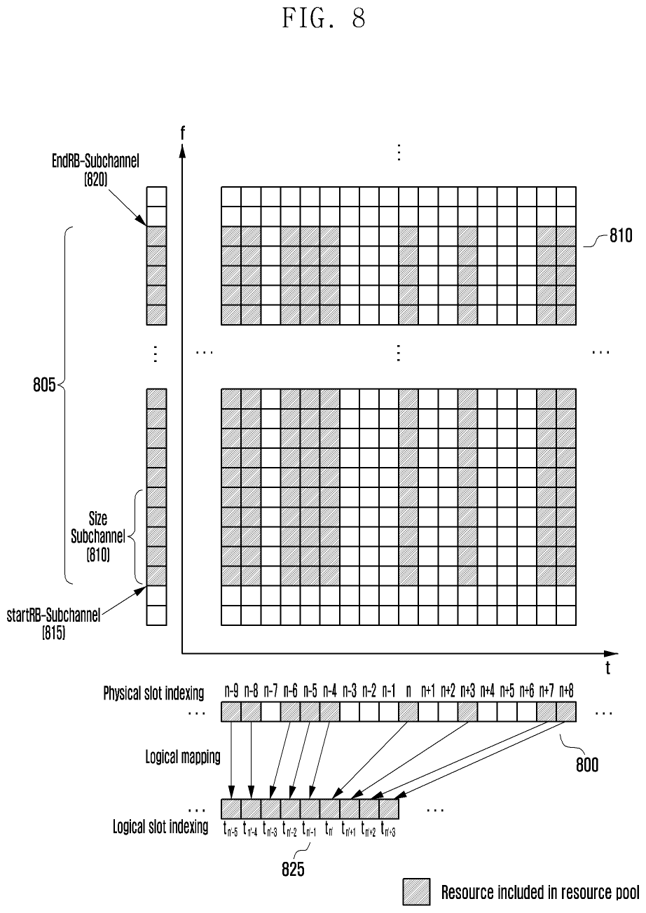

FIG. 8 illustrates an example of an SL resource pool in the wireless communication system according to an embodiment. A resource pool may be defined as a set of resources in the time and frequency domains, which are used for SL transmission and reception.

In a resource pool, a resource allocation unit (resource granularity) of the time axis may be one or more OFDM symbols. In addition, a resource granularity of the frequency axis may be one or more physical resource blocks (PRBs).

When a resource pool is allocated in the time domain and the frequency domain, an area including shaded resources indicates an area configured as a resource pool in time and frequency. In the disclosure, a description is provided for when a resource pool is allocated non-consecutively in time, but the disclosure is not limited thereto and may also be applied to when a resource pool is allocated consecutively in time. Description is provided herein for when a resource pool is allocated consecutively on frequency, but the disclosure is not limited thereto and may also be applied to when a resource pool is allocated non-consecutively on frequency.

Referring to FIG. 8, a time domain 800 of the configured resource pool illustrates when resources are non-consecutively allocated in the time domain. In the time domain 800 of the resource pool, the resource granularity of the time axis may be a slot. Specifically, one slot including 14 OFDM symbols may be a basic resource granularity of the time axis. Referring to the time domain 800 of the configured resource pool, shaded slots indicate slots allocated as a resource pool in time, and the slots allocated as the resource pool in time may be indicated using system information. For example, the slots allocated as the resource pool in time may be indicated using time domain resource pool configuration information in an SIB. Specifically, at least one slot configured as the resource pool in time may be indicated via a bitmap. Referring to FIG. 8, physical slots 800 belonging to the non-consecutive resource pool on the time axis may be mapped to logical slots 825. In general, a set of slots belonging to a resource pool for a physical sidelink shared channel (PSSCH) may be expressed as (t₀, t₁, . . . , tᵢ, . . . , t_{Tmax}).

In FIG. 8, a frequency domain 805 of the configured resource pool illustrates when resources are consecutively allocated in the frequency domain. In the frequency domain 805 of the resource pool, the resource granularity of the frequency axis may be a sub-channel 810. Specifically, a single sub-channel 810 including one or more resource blocks (RBs) may be defined as a basic resource granularity on frequency. That is, the sub-channel 810 may be defined to be an integer multiple of an RB. A sub-channel size (sizeSubchannel) may include five consecutive PRBs. However, the disclosure is not limited thereto, and a sub-channel size may be configured to be different. In addition, a single sub-channel generally includes consecutive PRBs, but the PRBs are not necessarily consecutive. The sub-channel 810 may be a basic resource granularity of for a PSSCH. In addition, a sub-channel for a physical sidelink feedback channel (PSFCH) may be defined independently of a PSSCH.

In FIG. 8, a start location of a sub-channel on frequency in the resource pool may be indicated by startRB-Subchannel 815. When resource allocation is performed in units of sub-channels 810 on the frequency axis, a resource pool on frequency may be configured via configuration information for an RB index (startRB-Subchannel) 815 indicating where a sub-channel starts, information (sizeSubchannel) 810 indicating the number of RBs constituting a sub-channel, and a total number (numSubchannel) of sub-channels. A resource pool on frequency may also be configured via configuration information for an RB index (EndRB-Subchannel) 820 indicating where a sub-channel ends. The sub-channels allocated as a resource pool on frequency may be indicated using system information. For example, at least one of startRB-Subchannel, sizeSubchannel, EndRB-SubChannel, and numSubchannel may be indicated as frequency resource pool configuration information in an SIB. When a sub-channel for a PSFCH is defined independently of a PSSCH, sub-channel configuration information of the PSFCH and the PSSCH may be indicated respectively to a UE.

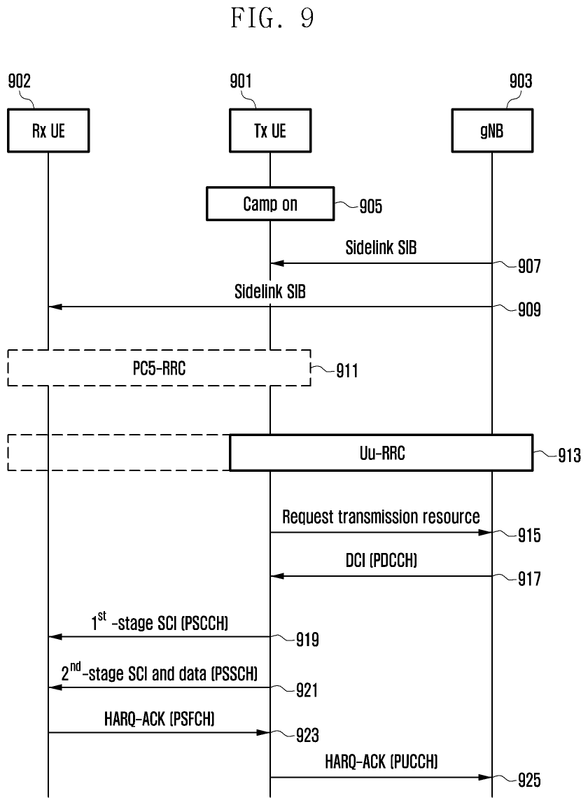

FIG. 9 illustrates an example of a signal flow for allocating transmission resources of a sidelink in the wireless communication system according to an embodiment. Referring to FIG. 9, a signal exchange between a transmission UE 901, a reception UE 902, and a base station 903 is shown.

A scheme in which a base station allocates a transmission resource for SL communication may be referred to as mode 1. Mode 1 is a scheme based on scheduled resource allocation by a base station. In mode 1 resource allocation, the base station may allocate, to RRC connected UEs, resources used for SL transmission according to a dedicated scheduling scheme. Since the base station is capable of managing sidelink resources, scheduled resource allocation may be advantageous for interference management and resource pool management (e.g., dynamic allocation and/or semi-persistent transmission).

Referring to FIG. 9, the transmission UE 901 camps on a cell in step 905, and the transmission UE 901 may receive a SL SIB from the base station 903. In step 909, the reception UE 902 may receive a SL SIB from the base station 903. The reception UE 902 refers to a UE that receives data transmitted by the transmission UE 901. The SL SIB may be transmitted periodically or on demand. The SL SIB may include at least one of SL resource pool information for SL communication, parameter configuration information for sensing operation, information for configuring SL synchronization, or information of carriers for SL communication operating at different frequencies. Although operations 907 and 909 have been described sequentially in the above, this is merely for convenience of description, and steps 907 and 909 may be performed in parallel.

In step 913, when data traffic for SL communication is generated in the transmission UE 901, the transmission UE 901 may be RRC-connected to the base station 903. The RRC connection between the transmission UE 901 and the base station 903 may be referred to as Uu-RRC. The Uu-RRC connection may be performed before data traffic of the transmission UE 901 is generated. In mode 1, when a Uu-RRC connection is established between the base station 903 and the reception UE 902, the transmission UE 901 may perform transmission to the reception UE 902 via an SL. In mode 1, even when a Uu-RRC connection is not established between the base station 903 and the reception UE 902, the transmission UE 901 may perform transmission to the reception UE 902 via an SL.

In step 915, the transmission UE 901 may request, from the base station 903, a transmission resource for performing SL communication with the receiving UE 902. In this case, the transmission UE 901 may request, from the base station 903, a transmission resource for an SL by using at least one of a physical uplink control channel (PUCCH), an RRC message, or a MAC CE. For example, when a MAC CE is used, the MAC CE may be related to a buffer status report (BSR) having a new form including at least one piece of information on an indicator for indicating a BSR for SL communication and a size of data stored in a buffer for device-to-device (D2D) communication (or V2X communication). This MAC CE may be referred to as an SL BSR MAC CE. In addition, when a PUCCH is used, the transmission UE 901 may request an SL resource by using a scheduling request (SR) bit transmitted via the PUCCH. In addition, when RRC is used, the transmission UE 901 may transfer, to the base station via Uu-RRC, information of the reception UE 902 and a frequency for transmission and reception of various types of SL communication including SL discovery, SL data communication, SL relay communication, and sidelink positioning procedure, and at least one piece of the following information may be included via the same or different RRC messages.
Frequency to be used for reception in SL communication
Frequency to be used for transmission in SL communication
Type of SL data transmitted in SL communication
Period and size of SL data transmitted in SL communication
Information (destination UE ID, UE capability, discontinuous reception (DRX) information, etc.) of a destination UE receiving SL data transmitted in SL communication
QoS information of SL data transmitted in SL communication
Cast type of SL data transmitted in SL communication
RLC mode of SL data transmitted in SL communication

In step 915, a PUCCH, a MAC CE, and an RRC message may be used independently of each other or may be used in a mixed manner depending on a purpose. In addition, although step 915 is described after step 913, this is for convenience of description. Step 915 may also be used for the transmission UE 901 to request a resource to establish a PC5-RRC 911 with respect to the reception UE 902, and may be performed in parallel or simultaneously with other operations.

In step 917, the base station 903 may transmit DL control information (DCI) to the transmission UE 901 via a PDCCH. That is, the base station 903 may indicate, to the transmission UE 901, scheduling information for SL communication with the reception UE 902. More specifically, the base station 903 may allocate a SL transmission resource to the transmission UE 901 according to at least one of a dynamic grant (DG) scheme or a configured grant (CG) scheme.

For the DG scheme, the base station 903 may allocate a resource for transmitting one TB, by transmitting the DCI to the transmission UE 901. SL scheduling information included in the DCI may include at least one of resource pool information, parameters related to an initial transmission occasion and/or a retransmission occasion, and parameters related to a frequency allocation location information field. The DCI for the DG scheme may be cyclic redundancy check (CRC)-scrambled based on a sidelink radio network temporary identifier (SL-RNTI) to indicate that a transmission resource allocation scheme is the DG scheme.

For the CG scheme, semi-persistent scheduling (SPS) information may be configured via Uu-RRC, and the SPS information may include an SPS interval. Based on the SPS interval, resources for transmitting multiple TBs may be periodically allocated. In this case, the base station 903 may allocate resources for multiple TBs by transmitting the DCI to the transmission UE 901. SL scheduling information included in the DCI may include at least one of parameters related to an initial transmission occasion and/or a retransmission occasion, and parameters related to a frequency allocation location information field. An initial transmission occasion and/or a retransmission occasion, and a frequency allocation location may be determined according to the transmitted DCI, and the resources may be repeated at the SPS interval. The DCI for the CG scheme may be CRC-scrambled based on an SL configured scheduling radio network temporary identifier (SL-CS-RNTI) to indicate that a transmission resource allocation scheme is the CG scheme.

The CG scheme may be divided into type 1 CG and type 2 CG. For type 2 CG, the base station 903 may activate and/or deactivate a resource configured by the CG via the DCI. Therefore, the base station 903 may indicate, to the transmission UE 901, scheduling for SL communication with the reception UE 902, by transmitting the DCI via the PDCCH.

When broadcast transmission is performed between the UEs 901 and 902, the transmission UE 901 may broadcast, in step 919, SCI to the reception UE 902 via a PSCCH without an additional PC5-RRC configuration (step 911). In step 921, the transmission UE 901 may broadcast data to the reception UE 902 via a PSSCH.

When unicast or groupcast transmission is performed between the UEs 901 and 902, the transmission UE 901 may perform one-to-one RRC connection to other UEs (e.g., the reception UE 902) in step 911. In this case, for distinction from Uu-RRC, the RRC connection between the UEs 901 and 902 may be referred to as PC5-RRC. In the groupcast transmission scheme, a PC5-RRC connection may be individually established between UEs within a group. Referring to FIG. 9, although the PC5-RRC connection (step 911) is illustrated as an operation after the SL SIB transmission (steps 907 and 909), the PC5-RRC connection (step 911) may be performed before the SL SIB transmission or before the SCI broadcast (step 919). If the RRC connection between the UEs is required, the SL PC5-RRC connection may be performed, and in step 919, the transmission UE 901 may transmit the SCI to the reception UE 902 via the PSCCH in unicast or groupcast. In this case, the groupcast transmission of the SCI may be understood as group SCI. In step 921, the transmission UE 901 may transmit the data to the reception UE 902 via the PSSCH in unicast or groupcast. In mode 1, the transmission UE 901 may identify SL scheduling information included in the DCI received from the base station 903, and perform SL scheduling based on the SL scheduling information. The SCI may be divided into 1st-stage SCI transmitted via the PSCCH and 2nd-stage SCI transmitted via the PSSCH, and the 1st-stage SCI may include at least one piece of the following information.
X Priority
X Frequency resource assignment
Time resource assignment
Resource reservation period
X De-modulation reference signal (DMRS) pattern
2nd-stage SCI format
Beta offset indicator
Number of DMRS port
Modulation and coding scheme
Additional modulation and coding scheme (MCS) table indicator
PSFCH overhead indication
Reserved
Conflict information receiver flag

Priority may be transmitted or configured via an upper layer and include 3 bits. In this case, a priority value of 1 may be configured to be 000, a priority value of 2 may be configured to be 001, and so on, and in this way, up to 8 priority values may be configured. A priority value of the SL data may have a highest value among priorities of MAC CEs or all logical channels included in a TB scheduled by the corresponding SCI. If a MAC CE or SCI for inter-UE coordination is transmitted, a priority value configured by an RRC parameter may be used instead of priority of the MAC CE. If there is no RRC parameter configuration, an inter-UE coordination request MAC CE may have a highest value among the priorities of MAC CEs or all logical channels included in the TB to be transmitted to the UE that receives the MAC CE, and an inter-UE coordination information MAC CE, which is transmitted to respond to the request by the UE having received the inter-UE coordination request MAC CE, may have the same value as a value corresponding a priority field within the inter-UE coordination request MAC CE. In addition, if the inter-UE coordination information MAC CE is transmitted based on a specific condition (e.g., if RSRP of a resource reserved by a third UE is greater than a specific value) rather than in response to the request from another UE, the UE may randomly select the priority from among values from 1 to 8.

When resources for multiple TBs (i.e., multiple MAC protocol data units (PDUs)) are selected, a reservation interval is indicated as a single value with a fixed interval between the TBs, and when a resource for one TB is selected, “0” may be indicated as an interval value between the TBs.

The 2nd-stage SCI may be included in a PSSCH resource indicated in the 1st-stage SCI transmitted in step 919, and may be transmitted along with the data in step 921. The 2nd-stage SCI may include at least one piece of the following information.
HARQ process number
New data indicator
Redundancy version
Source ID
Destination ID
HARQ feedback enabled/disabled indicator
Cast type indicator
Channel state information (CSI) request
Zone ID
Communication range requirement
Providing/Requesting indicator
Resource combinations
First resource location
Reference slot location
Resource set type
Lowest subChannel indices
Priority
Number of subchannels
Resource reservation period
Resource selection window location
Resource set type
Padding bits

In step 923, the reception UE 902 may transmit, to the transmission UE 901 via first HARQ feedback information, whether the data received in step 921 has been successfully demodulated/decoded. The first HARQ feedback information includes acknowledgement (ACK) (success) or negative ACK (NACK) (failure) information, and the reception UE 902 may transmit the first HARQ feedback information to the transmission UE 901 via a PSFCH.

In step 925, the transmission UE 901 may transmit second HARQ feedback information to the base station 903, based on the first HARQ feedback information received from the reception UE 902. The second HARQ feedback information may be transmitted to the base station via a PUCCH.

In this case, the second HARQ feedback information may be the same or may not be the same as the first HARQ feedback information. The second HARQ feedback information may include multiple pieces of the first HARQ feedback information. The multiple pieces of the first HARQ feedback information may include multiple pieces of HARQ feedback information received from a single reception UE or may include one or multiple pieces of HARQ feedback information received from multiple UEs.

Based on the second HARQ feedback information, the base station may allocate a resource for retransmission to the transmission UE 901, allocate a resource for new transmission, or stop resource allocation when there is no more transmission resource to be allocated to the transmission UE 901.

The PUCCH 925 transmission resource may be determined by the DCI transmitted by the base station to the transmission UE via the PDCCH 917. The PSFCH 923 transmission resource may be determined based on the SCI of the PSCCH 919 or may be determined based on a transmission resource area in which the PSSCH 921 is transmitted and received.

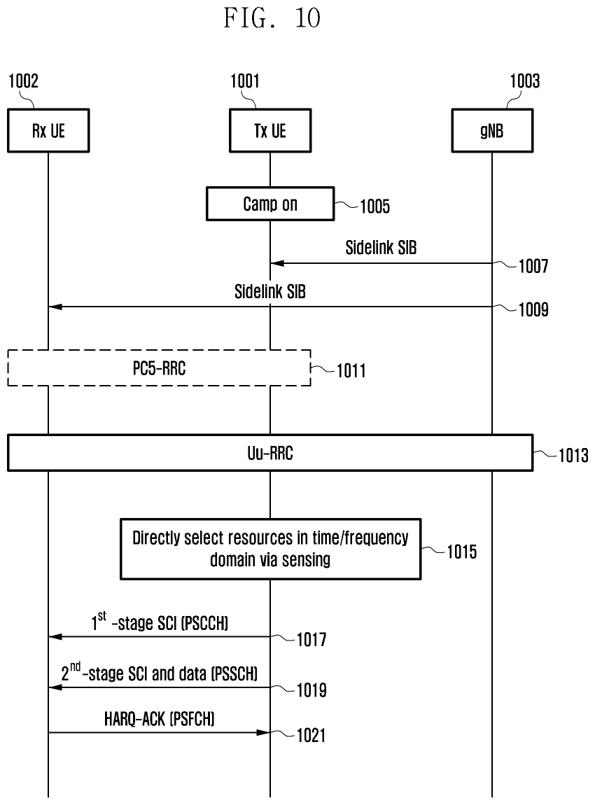

FIG. 10 illustrates another example of a signal flow for allocating transmission resources of an SL in the wireless communication system according to an embodiment. FIG. 10 illustrates a signal exchange between a transmission UE 1001, a reception UE 1002, and a base station 1003.

As described below, a scheme in which a UE directly allocates a SL transmission resource via sensing in an SL may be referred to as mode 2. Mode 2 may also be referred to as UE autonomous resource selection.

Specifically, according to mode 2, the transmission UE 1001 may provide SL communication information to the base station via an RRC message (e.g., SidelinkUEInformationNR). The base station 1003 may provide the UE with a SL transmission/reception resource pool for the SL via system information or an RRC message (e.g., RRC reconfiguration (RRCReconfiguration) message or a PC5 RRC message), and the transmission UE 1001 may select a resource pool and a resource according to a determined rule.

Unlike mode 1 described in FIG. 9, in which the base station is directly involved in resource allocation, mode 2 described in FIG. 10 allows the transmission UE 1001 to autonomously select a resource and transmit data, based on the resource pool previously received via the system information, the RRC message, or pre-configuration.

Referring to FIG. 10, in step 1007, the transmission UE 1001, which is camping on 1005, may receive a SL SIB from the base station 1003. In step 1009, the reception UE 1002 may receive a SL SIB from the base station 1003. The reception UE 1002 refers to a UE that receives data transmitted by the transmission UE 1001. The SL SIB may be transmitted periodically or on demand. In addition, SL SIB information may include at least one of SL resource pool information for SL communication, parameter configuration information for sensing operation, information for configuring SL synchronization, or information of carriers for SL communication operating at different frequencies. Although operations 1007 and 1009 have been described sequentially in the above, this is merely for convenience of description, and steps 1007 and 1009 may be performed in parallel.

In FIG. 9 described above, the base station 1003 and the transmission UE 1001 operate in an RRC connected state, whereas in FIG. 10, the base station 1003 and the transmission UE 1001 may operate regardless of whether an RRC connection is made between the base station 1003 and the transmission UE 1001 in step 1013. That is, the base station 1003 and the transmission UE 1001 may perform SL communication based on mode 2 even in an idle or inactive mode 1013 where no RRC connection is made. Even in the RRC connected state, the base station 1003 may operate to allow, without directly involving in resource allocation, the transmission UE 1001 to autonomously select a transmission resource. In this case, the RRC connection between the transmission UE 1001 and the base station 1003 may be referred to as Uu-RRC.

In step 1015, when data traffic for SL communication is generated in the transmission UE 1001, the transmission UE 1001 may be configured with a resource pool via system information received from the base station 1003, and may directly select time and frequency domain resources within the configured resource pool via sensing.

When broadcast transmission is performed between the UEs 1001 and 1002, the transmission UE 1001 may broadcast, in step 1017, SCI to the reception UE 1002 via a PSCCH without an additional SL RRC configuration (step 1011). In step 1019, the transmission UE 1001 may broadcast data to the reception UE 1002 via a PSSCH.

When unicast and groupcast transmission is performed between the UEs 1001 and 1002, the transmission UE 1001 may perform one-to-one RRC connection to other UEs (e.g., the reception UE 1002) in step 1011. In this case, for distinction from the Uu-RRC 1013, the RRC connection between the UEs 1001 and 1002 may be referred to as PC5-RRC. In the groupcast transmission scheme, a PC5-RRC connection is individually established between UEs within a group. In FIG. 10, although the PC5-RRC connection (step 1011) is illustrated as an operation after the SL SIB transmission (steps 1007 and 1009), the PC5-RRC connection (step 1011) may be performed before the SL SIB transmission or before the SCI transmission (step 1017). If the RRC connection between the UEs is required, the SL PC5-RRC connection may be performed, and in step 1017, the transmission UE 1001 may transmit the SCI to the reception UE 1002 via the PSCCH in unicast or groupcast. In this case, the groupcast transmission of the SCI may be understood as group SCI. In step 1019, the transmission UE 1001 may transmit the data to the reception UE 1002 via the PSSCH in unicast or groupcast. In mode 2, the transmission UE 1001 may directly perform SL scheduling by performing sensing and transmission resource selection. 1 st-stage SCI and 2nd-stage SCI used in steps 1017 and 1019 may be as shown in the example of FIG. 9.

In addition, when the transmission UE 1001 performs SL communication out of coverage (OOC), mode 2 resource allocation may be used, and for SL communication information available for this, information stored in the UE via pre-configuration may be used, or configuration information may be received from the base station via an SL relay.

In step 1021, the reception UE 1002 may transmit, to the transmission UE 1001 via HARQ feedback information, whether the data received in step 1019 has been successfully demodulated/decoded. The HARQ feedback information includes ACK (success) or NACK (failure) information, and the reception UE 1002 may transfer the HARQ feedback information to the transmission UE 1001 via a PSFCH.

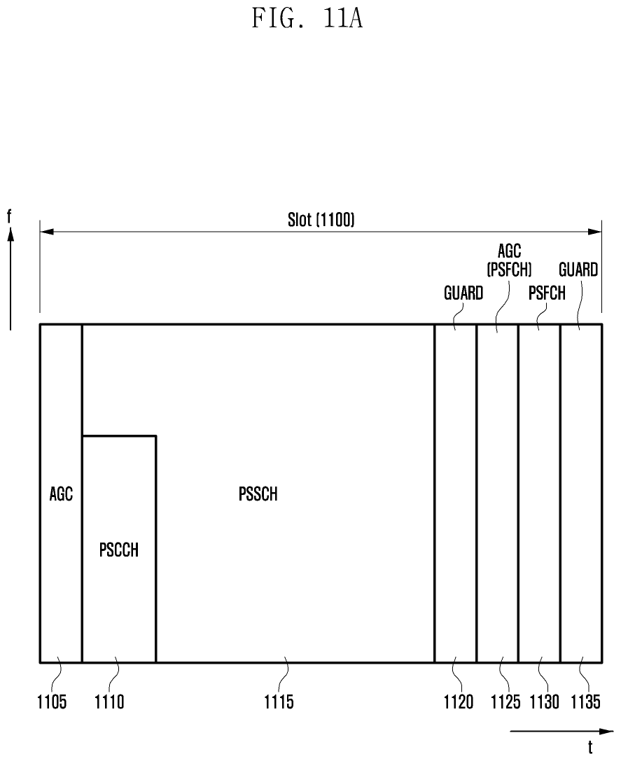

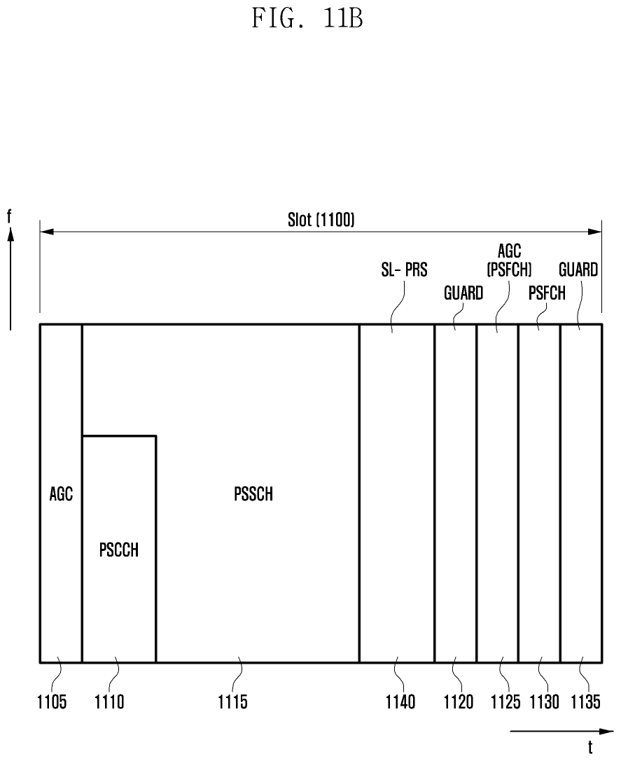

FIG. 11A illustrates an example of a channel structure of a slot used for SL communication in the wireless communication system according to various embodiments of the disclosure. FIG. 11A illustrates physical channels mapped to slots for SL communication.

Referring to FIG. 11A, an automatic gain control (AGC) 1105 available for a reception UE is mapped to a first symbol of a slot 1100. Then, a PSCCH 1110, a PSSCH 1115, a GUARD 1120, an AGC 1125 for PSFCH, a PSFCH 1130, and a GUARD 1135 may be sequentially mapped.

Before transmitting the PSCCH in the slot 1100, a transmission UE may transmit a signal for AGC having the same information as a symbol, in which the PSCCH 1110 is transmitted, in one or more symbols. The AGC symbol 1105 may be used to enable the reception UE to properly perform AGC to adjust an intensity of amplification when amplifying power of a reception signal. A signal for AGC may be referred to as a synchronization signal, an SL synchronization signal, a sidelink reference signal, midamble, an initial signal, a wake-up signal or other terms having an equivalent technical meaning.

The PSCCH 1110 including control information may be transmitted using symbols transmitted at the beginning of the slot, and the PSSCH 1115 scheduled by the control information of the PSCCH 1110 may be subsequently transmitted. At least a part of SCI that is control information may be mapped to the PSSCH 1115. Then, the GUARD 1120 and the AGC 1125 for PSFCH exist, and the PSFCH 1130 which is a physical channel for transmitting feedback information is mapped.

In FIG. 11A, the PSFCH 1130 is illustrated as being located in a second symbol from the end of the slot. By securing the GUARD 1120 that is a certain period of empty time between the PSSCH 1115 and the PSFCH 1130, the UE having transmitted or received the PSSCH 1115 may prepare to transmit or receive the PSFCH 1130 (e.g., switching between transmission and reception). The AGC 1125 for the PSFCH 1130 may exist. After the PSFCH 1130, the GUARD 1135 that is a certain period of an empty duration exists.

The UE may be preconfigured with a location of the slot, at which the PSFCH may be transmitted. Pre-configuration of the location may refer to a procedure for the location being predetermined while the UE is created, transferred when connecting to a sidelink-related system, transferred from a base station when connecting to the base station, or transferred from another UE.

In the embodiment of FIG. 11A, it has been described that a preamble signal for performing AGC is transmitted separately in a physical channel structure within a sidelink slot. Alternatively, instead of transmission of a separate preamble signal, it is also possible for a receiver of the reception UE to perform an AGC operation using a physical channel for control information or data transmission while receiving the physical channel for the control information or data transmission.

FIG. 11B illustrates an example of a channel structure of a slot used for SL communication and for a SL-PRS in the wireless communication system according to various embodiments of the disclosure. FIG. 11B illustrates physical channels mapped to slots for SL communication.

Referring to FIG. 11B, the AGC 1105 available for the reception UE may be mapped to the first symbol of the slot 1100. Then, the PSCCH 1110, the PSSCH 1115, the GUARD 1120, the AGC 1125 for PSFCH, the PSFCH 1130, and the GUARD 1135 may be sequentially mapped. In addition, an SL-PRS 1140 may be mapped to the slot 1100.

The SL-PRS 1140 may be mapped to at least one symbol among symbols available for the PSSCH 1115, and the corresponding symbol may be time-division multiplexed (TDMed) and transmitted while being separated from other physical channels by the time axis. Therefore, the SL-PRS 1140 may affect the number of resource elements (REs) available for the PSSCH 1115. Therefore, when transmitting an SL signal including the SL-PRS 1140, a resource amount used for the PSSCH 1115 may be different, and resource allocation for SL data is required in consideration of the symbol in which the SL-PRS is transmitted.

The SL-PRS 1140 may be distinguished by information which is distinguishable and pre-configured by 1st-stage SCI, 2nd-stage SCI, or other configurations, for example, a resource set of the SL-PRS transmitted by the transmission UE, time/frequency resources, Comb N of the SL-PRS, symbol M, a start symbol, an SL-PRS frequency offset, etc.

For a shared resource pool in which the SL-PRS may be transmitted together with the PSSCH 1115 for transmission of the SL data and the 2nd-SCI, the reception UE may identify, via the 1st-stage SCI and 2nd-stage SCI, whether a transmission target of the SL-PRS 1140 is the reception UE. In addition, a UE other than a destination of the SL-PRS 1140 according to the 1 st-stage SCI and/or the 2nd-stage SCI may also receive the SL-PRS. In this case, the UE may determine whether to receive the SL-PRS 1140, via Layer-1 ID or Layer-2 ID of the transmission UE, which is included in the 1st-stage SCI and 2nd-stage SCI, and information (e.g., SL-PRS pattern information and SL-PRS resource information) included in the 1st-stage SCI and the 2nd-stage SCI.

In addition, for a dedicated resource pool in which only the SL-PRS 1140 is transmitted without transmission of the PSSCH 1115, at least one of the PSSCH 1115, the GUARD 1120, the AGC (PSFCH) 1125, the PSFCH 1130, and the GUARD 1135 may not be included in the slot 1100, and one UE may transmit the SL-PRS 1140 to multiple UEs in one slot 1100. To this end, at least one PSCCH 1110 including destination UE information may be included. When the PSCCH 1110 includes one or more pieces of the 1st-stage SCI and has one or more associated SL-PRSs 1140, one piece of the 1 st-stage SCI may indicate one SL-PRS 1140 (1:1 mapping), multiple pieces of the 1st-stage SCI may indicate one SL-PRS 1140 (N:1 mapping), or one piece of the 1st-stage SCI may indicate one or more SL-PRSs 1140 (1:N mapping).

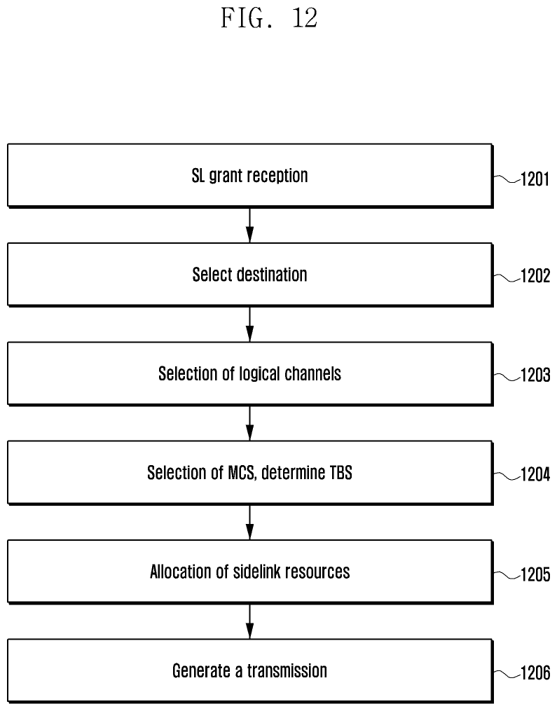

FIG. 12 illustrates a procedure for a transmission UE to transmit SL data in the wireless communication system according to an embodiment.

Referring to FIG. 12, in step 1201, a transmission UE (or a MAC entity of the transmission UE) may receive a grant (SL grant) for SL transmission, as in the example of FIG. 9 or FIG. 10. The SL grant is information indicating a set of resources, and the transmission UE may determine, based on the SL grant, a duration in which a PSCCH may be transmitted and durations in which a PSSCH may be transmitted.

In step 1202, the transmission UE may select a destination to receive SL data transmitted based on the SL grant associated with each piece of SCI associated with new transmission. The destination may be within an active time based on SL DRX, or may be a destination for which at least one MAC CE or logical channel has highest priority. The destination may be selected based on criteria as shown below in Table 1.

```
TABLE 1
1> if sl-BWP-DiscPoolConfig or sl-BWP-DiscPoolConfigCommon is configured according
  to TS 38.331 [5]:
  2> if the new transmission is associated to a sidelink grant in sl-DiscTxPoolSelected or
    sl-DiscTxPoolScheduling configured in sl-BWP-DiscPoolConfig or sl-BWP-
    DiscPoolConfigCommon:
    3> select a Destination associated with NR sidelink discovery as specified in TS
      23.304 [26], that is in the SL Active time for the SL transmission occasion if SL
      DRX is applied for the destination, and among the logical channels that satisfy all
      the following conditions for the SL grant associated to the SCI:
      4> SL data for NR sidelink discovery is available for transmission; and
      4> SBj > 0, in case there is any logical channel having SBj > 0; and
    4> sl-configuredGrantType1Allowed, if configured, is set to true in case the SL
      grant is a Configured Grant Type 1; and
    4> sl-AllowedCG-List, if configured, includes the configured grant index
      associated to the SL grant.
  2> else:
    3> select a Destination associated to one of unicast, groupcast and broadcast
      (excluding the Destination(s) associated with NR sidelink discovery as specified in
      TS 23.304 [26]), that is in the SL Active time for the SL transmission occasion if
      SL DRX is applied for the destination, and having at least one of the MAC CE and
      the logical channel with the highest priority, among the logical channels that
      satisfy all the following conditions and MAC CE(s), if any, for the SL grant
      associated to the SCI:
      4> SL data for NR sidelink communication is available for transmission; and
      4> SBj > 0, in case there is any logical channel having SBj > 0; and
      4> sl-configuredGrantTypelAllowed, if configured, is set to true in case the SL
        grant is a Configured Grant Type 1; and
      4> sl-AllowedCG-List, if configured, includes the configured grant index
        associated to the SL grant; and
      4> sl-HARQ-FeedbackEnabled is set to disabled, if PSFCH is not configured for
        the SL grant associated to the SCI.
1> else:
  2> select a Destination associated to one of unicast, groupcast and broadcast, that is in
    the SL Active time for the SL transmission occasion if SL DRX is applied for the
    destination, and having at least one of the MAC CE and the logical channel with the
    highest priority, among the logical channels that satisfy all the following conditions
    and MAC CE(s), if any, for the SL grant associated to the SCI:
    3> SL data is available for transmission; and
    3> SBj > 0, in case there is any logical channel having SBj > 0; and
    3> sl-configuredGrantTypelAllowed, if configured, is set to true in case the SL grant
      is a Configured Grant Type 1; and
    3> sl-AllowedCG-List, if configured, includes the configured grant index associated to
      the SL grant; and
    3> sl-HARQ-FeedbackEnabled is set to disabled, if PSFCH is not configured for the
      SL grant associated to the SCI.
NOTE 1:
If multiple Destinations have the logical channels satisfying all conditions above with the same highest priority or if multiple Destinations have either the MAC CE and/or the logical channels satisfying all conditions above with the same priority as the MAC CE, which Destination is selected among them is up to UE implementation.
```

In step 1203, the transmission UE may select logical channels to be transmitted to the selected destination. If the SL data to be transmitted is in a logical channel, if a logical channel is available for a CG of the SL grant, or if a logical channel is configured to use HARQ feedback, the transmission UE may select appropriate logical channels based on whether HARQ feedback is supported. These logical channels may be selected according to criteria as shown below in Table 2.

```
TABLE 2
1> select the logical channels satisfying all the following conditions among the logical
  channels belonging to the selected Destination:
  2> SL data is available for transmission; and
  2> sl-configuredGrantTypelAllowed, if configured, is set to true in case the SL grant is a
    Configured Grant Type 1; and.
  2> sl-AllowedCG-List, if configured, includes the configured grant index associated to
    the SL grant; and
  2> sl-HARQ-FeedbackEnabled is set to the value that satisfies the following conditions:
    3> if PSFCH is configured for the sidelink grant associated to the SCI and the UE is
      capable of PSFCH reception:
      4> sl-HARQ-FeedbackEnabled is set to enabled, if sl-HARQ-FeedbackEnabled is
        set to enabled for the highest priority logical channel satisfying the above
        conditions; or
      4> sl-HARQ-FeedbackEnabled is set to disabled, if sl-HARQ-FeedbackEnabled is
        set to disabled for the highest priority logical channel satisfying the above
        conditions.
    3> else:
      4> sl-HARQ-FeedbackEnabled is set to disabled.
NOTE 2:
HARQ feedback enabled/disabled indicator is set to disabled for the transmission of a MAC PDU only carrying CSI reporting MAC CE or Sidelink DRX Command MAC CE or Sidelink Inter-UE Coordination Request MAC CE or Sidelink Inter-UE Coordination Information MAC CE.
```

In step 1204, the transmission UE may select an MCS (or MCS table) to be used in resources related to the SL grant present (existing or occurring) in the duration in which a PSSCH may be transmitted. In the MCS, a maximum value and a minimum value may be determined by a transmission configuration (TxConfig) that may be determined by highest priority of logical channels included in the resources to be transmitted, a channel busy ratio (CBR), etc. The transmission UE may transmit the selected MCS and the SL grant for the corresponding PSSCH duration to an associated SL HARQ entity. The transmission UE may determine the number of symbols and REs available for the SL grant and a size (TBS or TB Size) of a TB that may be transmitted via the selected MCS.

In step 1205, the transmission UE may allocate resources for transmitting the SL data or MAC CEs. The transmission UE (or the MAC entity of the transmission UE) may apply RRC parameters (e.g., sl-Priority, sl-PrioritisedBitRate (sPBR), and sl-BucketSizeDuration (sBSD)) for SL data transmission for each logical channel, and SBj is maintained for each logical channel j. SBj is increased by a value obtained by multiplying sPBR by time, and is initialized to 0 when the logical channel is established. In addition, if SBj is greater than a product (SL bucket size) of sPBR and sBSD, the SBj is configured as an SL bucket size. This procedure may be expressed as shown below in Table 3.

```
TABLE 3
The sidelink Logical Channel Prioritization procedure is applied whenever a new transmission
is performed.
RRC controls the scheduling of sidelink data by signalling for each logical channel:
  - sl-Priority where an increasing priority value indicates a lower priority level;
  - sl-PrioritisedBitRate which sets the sidelink Prioritized Bit Rate (sPBR);
  - sl-BucketSizeDuration which sets the sidelink Bucket Size Duration (sBSD).
RRC additionally controls the LCP procedure by configuring mapping restrictions for each
logical channel:
  - sl-configuredGrantTypelAllowed which sets whether a configured grant Type 1 can be
    used for sidelink transmission;
  - sl-AllowedCG-List which sets the allowed configured grant(s) for sidelink transmission;
  - sl-HARQ-FeedbackEnabled which sets whether the logical channel is allowed to be
    multiplexed with logical channel(s) with sl-HARQ-FeedbackEnabled set to enabled or
    disabled.
The following UE variable is used for the Logical channel prioritization procedure:
  - SBj which is maintained for each logical channel j.
The MAC entity shall initialize SBj of the logical channel to zero when the logical channel is
established.
For each logical channel j, the MAC entity shall:
  1> increment SBj by the product sPBR × T before every instance of the LCP procedure,
    where T is the time elapsed since SBj was last incremented;
  1> if the value of SBj is greater than the sidelink bucket size (i.e. sPBR × sBSD):
    2> set SBj to the sidelink bucket size.
NOTE:
The exact moment(s) when the UE updates SBj between LCP procedures is up to UE implementation, as long as SBj is up to date at the time when a grant is processed by LCP.
```

The transmission UE may allocate resources in the order of high priority (high priority is indicated for low sl-Priority) for logical channels with SBj greater than 0 among the selected logical channels, and configure a MAC PDU. This procedure may be expressed as shown below 5 in Table 4.

```
TABLE 4
The MAC entity shall for each SCI corresponding to a new transmission:
  1> allocate resources to the logical channels as follows:
    2> logical channels selected in clause 5.22.1.4.1.2 for the SL grant with SBj > 0 are
      allocated resources in a decreasing priority order. If the sPBR of a logical channel is
      set to infinity, the MAC entity shall allocate resources for all the data that is available
      for transmission on the logical channel before meeting the sPBR of the lower priority
      logical channel(s);
    2> decrement SBj by the total size of MAC SDUs served to logical channel j above;
    2> if any resources remain, all the logical channels selected in clause 5.22.1.4.1.2 are
      served in a strict decreasing priority order (regardless of the value of SBj) until either
      the data for that logical channel or the SL grant is exhausted, whichever comes first.
      Logical channels configured with equal priority should be served equally.
NOTE 1:
The value of SBj can be negative.
```

In this case, a size available for resource allocation may be determined based on the TBS obtained in step 1204.

In step 1206, the transmission UE may transmit the SL data to the reception UE. A specific UE operation is as follows.

The HARQ entity of the transmission UE may request data transmission from a SL process of the transmission UE. The HARQ entity of the transmission UE may determine SL transmission information. The SL transmission information may include at least one of a source Layer-1 ID, a destination Layer-1 ID, a SL process ID, an HARQ process ID, a cast type, HARQ feedback, and priority. The HARQ entity may transfer the SL transmission information and the MAC PDU to the SL process. The SL process may identify whether the MAC PDU is transmittable, based on whether priority of the MAC PDU is greater than priority of UL or other transmission. If the MAC PDU is transmittable, the SL process may indicate a PHY layer to transmit SCI according to the SL grant along with the SL transmission information, and may indicate generation of transmission according to the stored SL grant so as to transmit the SL data to another UE.

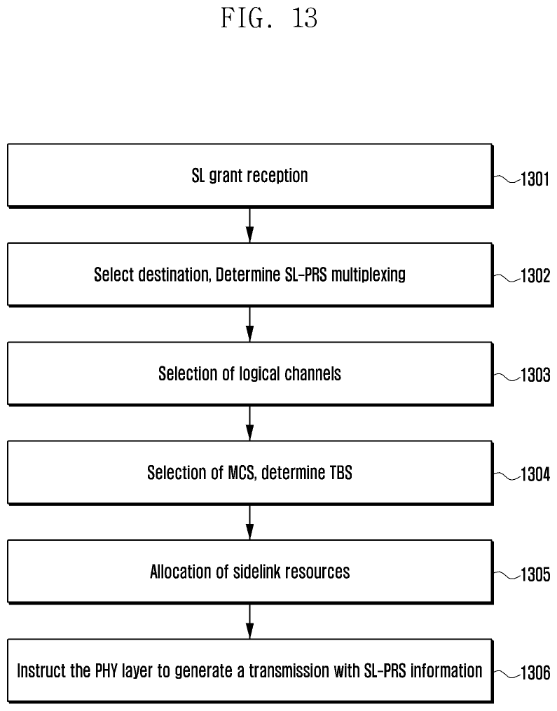

FIG. 13 illustrates a procedure for a transmission UE to transmit SL data and an SL-PRS in the wireless communication system according to various embodiments of the disclosure.

In step 1301, a transmission UE (or a MAC entity of the transmission UE) may receive an SL grant for SL transmission, as in the example of FIG. 9 or FIG. 10. The SL grant is information indicating a set of resources, and the transmission UE may determine, based on the SL grant, a duration in which a PSCCH may be transmitted and durations in which a PSSCH may be transmitted. The SL grant may be a SL grant assuming that an SL-PRS is multiplexed with a PSSCH by an indication of a base station (e.g., DCI) or an indication of a PHY layer. Via the SL grant assuming that an SL-PRS is multiplexed with a PSSCH, the transmission UE may always include an SL-PRS or may predetermine a second TBS (2nd-TBS) of operation 1406 to be described later.

In step 1302, the transmission UE may select a destination to receive SL data transmitted based on the SL grant associated with each piece of SCI associated with new transmission. The destination may be within an active time based on SL DRX, or may be a destination for which at least one MAC CE, logical channel, or SL-PRS has highest priority. At least one SL-PRS destination may be selected. The destination may be selected to satisfy at least one of the following conditions.

When there is a destination to which an SL-PRS should be transmitted, the transmission UE may select a UE, which needs to receive an SL-PRS, as a destination regardless of priority of a logical channel or an SL-PRS.

When there are multiple UEs as destinations receiving an SL-PRS, the transmission UE may select a destination having an SL-PRS with highest priority among SL-PRSs.

The transmission UE may select a destination including a logical channel or an SL-PRS so as not to exceed a range of a delay budget or a remaining delay budget in consideration of a packet delay budget of the logical channel, a delay requirement or delay budget of the SL-PRS, or a remaining packet delay budget (PDB) of the logical channel and a remaining delay budget of the SL-PRS, and a remaining time until a PSSCH or SL-PRS transmission duration, or may select a destination having a lowest remaining delay budget.

A bandwidth in which an SL-PRS is transmittable may vary depending on the SL grant, and if the bandwidth of the SL grant does not meet a bandwidth required for SL-PRS transmission, a corresponding destination may be excluded.

The transmission UE may select a destination without considering an SL-PRS, as shown in FIG. 12, regardless of the presence or absence of an SL-PRS to be transmitted to the destination of SL-PRS, and in this case, the SL-PRS transmitted together with SL data that is transmitted to the selected destination may be an SL-PRS transmitted to the selected destination and/or another UE.

If the transmission UE is able to transmit an SL-PRS to the selected destination or another UE in a corresponding PSSCH duration, transmission (multiplexing) of the PSSCH and the SL-PRS may be determined. In this case, information of a physical channel (e.g., at least one of a bandwidth, the number of symbols, a start symbol of the SL-PRS, a combination pattern of the SL-PRS, an SL-PRS resource set, and an SL-PRS frequency offset) for configuring the SL-PRS may be stored and used for a subsequent procedure.

In step 1303, the transmission UE may select logical channels to be transmitted to the selected destination. If the SL data to be transmitted is in a logical channel, if a logical channel is available for a CG of the SL grant, or if a logical channel is configured to use HARQ feedback, the transmission UE may select appropriate logical channels based on whether HARQ feedback is supported.

In step 1304, the transmission UE may select an MCS (or MCS table) to be used in resources related to the SL grant present (existing or occurring) in the duration in which a PSSCH may be transmitted. In the MCS, a maximum value and a minimum value may be determined by a transmission configuration (TxConfig) that may be determined by highest priority of SL-PRSs or logical channels included in the resources to be transmitted, a channel busy ratio (CBR), etc. The transmission UE may transmit the selected MCS and the SL grant for the PSSCH resources to an associated sidelink HARQ entity. The transmission UE may determine the number of symbols and REs available for the SL grant and a TBS that may be transmitted via the selected MCS. If transmission of an SL-PRS is determined in step 1302, the transmission UE may determine a TBS in consideration of a resource in which the SL-PRS is transmitted. That is, the transmission UE may determine a TBS excluding the resource on which the SL-PRS is transmitted.

In step 1305, the transmission UE may allocate resources for transmitting the SL data or MAC CEs. The transmission UE (or the MAC entity of the transmission UE) may apply RRC parameters (e.g., sl-Priority, sl-PrioritisedBitRate (sPBR), and sl-BucketSizeDuration (sBSD)) for SL data transmission for each logical channel, and SBj is maintained for each logical channel j. SBj is increased by a value obtained by multiplying sPBR by time, and is initialized to 0 when the logical channel is established. In addition, if SBj is greater than a product (SL bucket size) of sPBR and sBSD, the SBj is configured as an SL bucket size. This procedure may be expressed as in Table 3.

The transmission UE may allocate resources in the order of high priority (high priority is indicated for low sl-Priority) for logical channels with SBj greater than 0 among the selected logical channels, and configure a MAC PDU. In this case, a size available for resource allocation may be determined based on the TBS obtained in step 1304.

In step 1306, the transmission UE may transmit the SL data to the reception UE. A specific UE operation is as follows.

The HARQ entity of the transmission UE may request data transmission from a sidelink process of the transmission UE. The HARQ entity of the transmission UE may determine SL transmission information to be included in SCI. The SL transmission information may include at least one of a source Layer-1 ID, a destination Layer-1 ID, an SL process ID, an HARQ process ID, a cast type, HARQ feedback, and priority. The HARQ entity may transfer the SL transmission information and the MAC PDU to the SL process. If SL data transmission information is different from SL-PRS transmission information (e.g., when priorities are different), the transmission UE may determine the SL transmission information by using higher priority among the priority of the SL data and the priority of the SL-PRS, or may store the priority of the SL data and the priority of the SL-PRS, respectively, and transmit the same to the PHY layer. The SL process may identify whether the MAC PDU is transmittable, based on whether priority of the MAC PDU is greater than priority of UL or other transmission. If the MAC PDU is transmittable, the SL process may indicate the PHY layer to transmit SCI according to the SL grant along with the SL transmission information, and may indicate generation of transmission according to the stored SL grant so as to transmit the SL data to another UE.

If transmission of the SL-PRS and the SL data should be indicated together to the PHY layer, information of a physical channel (e.g., a bandwidth, comb N, symbol M, an SL-PRS frequency offset, an SL-PRS start symbol, and an SL-PRS resource set ID) for configuring the SL-PRS may also be transmitted so as to be used when the PHY layer generates a signal.

The information of the physical channel for configuring the SL-PRS may be pre-configured by the base station via RRC, SIB, and pre-configuration, and each piece of information may be mapped to an ID. For example, a specific ID may indicate at least one of a bandwidth, comb N, symbol M, an SL-PRS frequency offset, and an SL-PRS start symbol associated with the ID. Alternatively, the transmission UE may transmit request information associated with a specific destination and service to the base station in advance via an RRC message, etc., and the base station may provide an available SL-PRS resource set and a mapping ID, based on the request information.

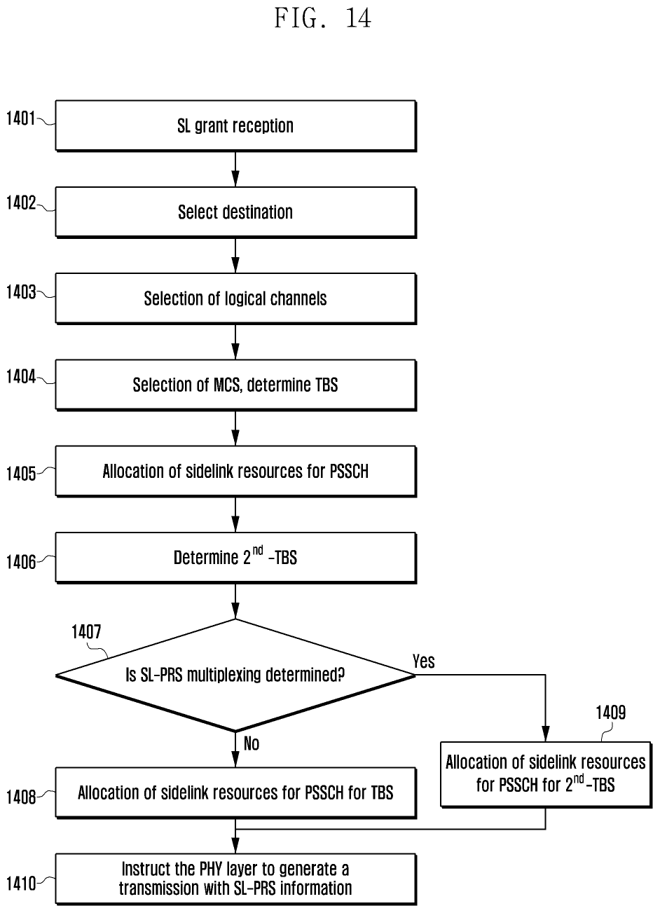

FIG. 14 illustrates a procedure for a transmission UE to transmit SL data and an SL-PRS in the wireless communication system according to various embodiments of the disclosure.

In step 1401, a transmission UE (or a MAC entity of the transmission UE) may receive an SL grant for SL transmission, as in the example of FIG. 9 or FIG. 10. The SL grant is information indicating a set of resources, and the transmission UE may determine, based on the SL grant, a duration in which a PSCCH may be transmitted and durations in which a PSSCH may be transmitted. The SL grant may be a SL grant assuming that an SL-PRS is multiplexed with a PSSCH by an indication of a base station (e.g., DCI) or an indication of a PHY layer. Based on the SL grant assuming that an SL-PRS is multiplexed, the transmission UE may include an SL-PRS or may first determine a second TBS (2nd-TBS) of step 1406 to be described later.

In step 1402, the transmission UE may select a destination to receive SL data transmitted based on the SL grant associated with each SCI associated with new transmission. The destination may be within an active time based on SL DRX, or may be a destination for which at least one MAC CE, logical channel, or SL-PRS has highest priority. At least one SL-PRS transmission target may be selected. The destination may be selected to satisfy at least one of the following conditions.

When there is a destination to which an SL-PRS should be transmitted, the transmission UE may select a UE, which needs to receive an SL-PRS, as a destination regardless of priority of a logical channel or an SL-PRS.

When there are multiple UEs as destinations receiving an SL-PRS, the transmission UE may select a destination having an SL-PRS with highest priority among SL-PRSs.

The transmission UE may select a destination including a logical channel or an SL-PRS so as not to exceed a range of a delay budget or a remaining delay budget in consideration of a packet delay budget of the logical channel, a delay requirement or delay budget of the SL-PRS, or a remaining packet delay budget (PDB) of the logical channel and a remaining delay budget of the SL-PRS, and a remaining time until a PSSCH or SL-PRS transmission duration, or may select a destination having a lowest remaining delay budget.

A bandwidth in which an SL-PRS is transmittable may vary depending on the SL grant, and if the bandwidth of the SL grant does not meet a bandwidth required for SL-PRS transmission, a corresponding destination may be excluded.

The transmission UE may select a destination without considering an SL-PRS, as shown in FIG. 12, regardless of the presence or absence of an SL-PRS to be transmitted to the destination of SL-PRS, and in this case, the SL-PRS transmitted together with SL data that is transmitted to the selected destination may be an SL-PRS transmitted to the selected destination and/or another UE.

In step 1403, the transmission UE may select logical channels to be transmitted to the selected destination. If the SL data to be transmitted is in a logical channel, if a logical channel is available for a CG of the SL grant, or if a logical channel is configured to use HARQ feedback, the transmission UE may select appropriate logical channels based on whether HARQ feedback is supported.

In step 1404, the transmission UE may select an MCS (or MCS table) to be used in resources related to the SL grant present (existing or occurring) in the duration in which a PSSCH may be transmitted. In the MCS, a maximum value and a minimum value may be determined by a transmission configuration (TxConfig) that may be determined by highest priority of SL-PRSs or logical channels included in the resources to be transmitted, a channel busy ratio (CBR), etc. The transmission UE may transmit the selected MCS and the SL grant for the PSSCH resources to an associated sidelink HARQ entity. The transmission UE may determine a TBS based on the number of symbols and REs available for the SL grant and the selected MCS.

In step 1405, the transmission UE may allocate resources for transmitting the SL data or MAC CEs. The transmission UE (or the MAC entity of the transmission UE) may apply RRC parameters (e.g., sl-Priority, sl-PrioritisedBitRate (sPBR), and sl-BucketSizeDuration (sBSD)) for SL data transmission for each logical channel, and SBj is maintained for each logical channel j. SBj is increased by a value obtained by multiplying sPBR by time, and is initialized to 0 when the logical channel is established. If SBj is greater than a product (SL bucket size) of sPBR and sBSD, the SBj is configured as an SL bucket size. This procedure may be expressed as in [Table 3].

The transmission UE may allocate resources in the order of high priority (high priority is indicated for low sl-Priority) for logical channels with SBj greater than 0 among the selected logical channels, and configure a MAC PDU. In this case, a size available for resource allocation may be determined based on the TBS obtained in step 1404. When there is an SL-PRS to be transmitted to the selected destination or another UE in the PSSCH duration, and there is a logical channel having higher priority than priority of the SL-PRS, the UE may allocate as many resources as SBj associated with logical channels having higher priority than the priority of the SL-PRS, or allocate as many resources as SBj associated with logical channels having the same or higher priority as the priority of the SL-PRS.

If the priority of the SL-PRS and the priority of the logical channels are the same, the transmission UE may preferentially add the SL-PRS, preferentially add data of the logical channels, or preferentially add the logical channels or SL-PRS, which should be transmitted earlier, by comparing a remaining packet delay budget (PDB) of each of the logical channels with a remaining delay budget of the SL-PRS. Alternatively, depending on UE implementation, it may be determined which logical channel among the logical channels having the same priority as the priority of the SL-PRS is included.

After the transmission UE allocates data of the logical channels having the same priority or higher priority than the priority of the SL-PRS in step 1405, when there is a remaining allocatable resource, the transmission UE may determine a TBS including the SL-PRS in step 1406. For the TBS, a symbol for SL-PRS transmission may be excluded. The TBS determined including the SL-PRS may be referred to as a second TBS (2nd-TBS) to be distinguished from the TBS determined in step 1404.

In step 1407, the transmission UE may determine not to transmit the SL-PRS with the SL data if the second TBS (2nd-TBS) determined in step 1406 is of a size unavailable for allocation of the logical channel data included in step 1405. When it is determined not to transmit the SL-PRS with the SL data, the transmission UE may perform step 1408.

Further in step 1407, the transmission UE may determine to transmit the SL-PRS with the SL data in consideration of the remaining delay budget of the SL-PRS or the delay budget of the logical channel even if the 2nd TBS (2nd-TBS) has a size unavailable for allocation of the logical channel data included in step 1405. Alternatively, the transmission UE may determine to transmit the SL-PRS with the SL data according to UE implementation even if the 2nd TBS (2nd-TBS) has a size unavailable for allocation of the logical channel data included in step 1405. If the 2nd TBS (2nd-TBS) has a size available for allocation of the data of the logical channels included in step 1405, the transmission UE may determine to transmit the SL-PRS with the SL data. When it is determined to transmit the SL-PRS with the SL data, the transmission UE may perform operation 1409.

In step 1408, the transmission UE may allocate the data of the logical channels to the remaining resources of the TBS, as shown above in Table 4. In this case, the SL-PRS may not be multiplexed.

In step 1409, the transmission UE may allocate the data of the logical channels to the remaining resources of the 2nd TBS (2nd-TBS), as shown in Table 4. The 2nd TBS (2nd-TBS) may be determined in step 1406 in which the SL-PRS and the PSSCH are multiplexed to be transmitted together. Determination and comparison of the 2nd TBS (2nd-TBS) may be performed in step 1404 or another operation.

In step 1410, the transmission UE may transmit the SL data to the reception UE. A specific UE operation is as follows.

The HARQ entity of the transmission UE may request data transmission from a SL process of the transmission UE. The HARQ entity of the transmission UE may determine SL transmission information. The SL transmission information may include at least one of a source Layer-1 ID, a destination Layer-1 ID, a SL process ID, an HARQ process ID, a cast type, HARQ feedback, and priority. The HARQ entity may transfer the SL transmission information and the MAC PDU to the SL process. If SL data transmission information is different from SL-PRS transmission information (e.g., when priorities are different), the transmission UE may determine the SL transmission information by using higher priority among the priority of the SL data and the priority of the SL-PRS, or may store the priority of the SL data and the priority of the SL-PRS, respectively, and transmit the same to the PHY layer. The SL process may identify whether the MAC PDU is transmittable, based on whether priority of the MAC PDU is greater than priority of UL or other transmission. If the MAC PDU is transmittable, the SL process may indicate the PHY layer to transmit SCI according to the SL grant along with the SL transmission information, and may indicate generation of transmission according to the stored SL grant so as to transmit the SL data to another UE.

If transmission of the SL-PRS and the SL data should be indicated together to the PHY layer, information of a physical channel (e.g., a bandwidth, comb N, symbol M, an SL-PRS frequency offset, an SL-PRS start symbol, and an SL-PRS resource set ID) for configuring the SL-PRS may also be transmitted so as to be used when the PHY layer generates a signal.

The information of the physical channel for configuring the SL-PRS may be pre-configured by the base station via RRC, SIB, and pre-configuration, and each piece of information may be mapped to an ID. For example, a specific ID may indicate at least one of a bandwidth, comb N, symbol M, an SL-PRS frequency offset, and an SL-PRS start symbol associated with the ID. Alternatively, the transmission UE may transmit request information associated with a specific destination and service to the base station in advance via an RRC message, etc., and the base station may provide an available SL-PRS resource set and a mapping ID, based on the request information.

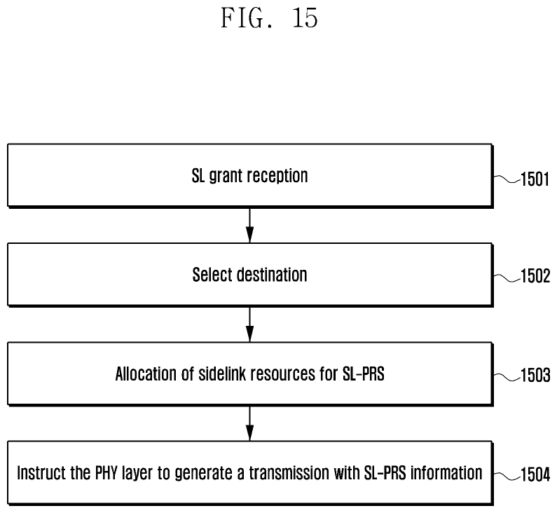

FIG. 15 illustrates a procedure for a transmission UE to transmit an SL-PRS in the wireless communication system according to an embodiment.

In step 1501, a transmission UE (or a MAC entity of the transmission UE) may receive a grant (SL grant) for SL transmission, as in the example of FIG. 9 or FIG. 10. The SL grant is information indicating a set of resources, and the transmission UE may determine, based on the SL grant, a duration in which a PSCCH may be transmitted and durations in which a PSSCH may be transmitted. The SL grant may be a SL grant using an SL-PRS designated resource pools in which no PSSCH is transmitted.

In step 1502, the transmission UE may select at least one destination to receive SL data transmitted based on the SL grant associated with each piece of SCI associated with new SL-PRS transmission. The destination may be within an active time based on SL DRX, or may be a destination for which at least one SL-PRS has highest priority. At least one SL-PRS transmission target may be selected. The destination may be selected to satisfy at least one of the following conditions.

When there are multiple UEs as destinations receiving an SL-PRS, the transmission UE may select a destination having an SL-PRS with highest priority among SL-PRSs. Alternatively, for as many destinations, which receive an SL-PRS, as the number of target UEs to which transmission is possible via the SL grant, all the destinations may be selected in the order of high priority or regardless of priority.

The transmission UE may select at least one destination including an SL-PRS so as not to exceed a range of a delay budget or a remaining delay budget in consideration of a delay requirement or delay budget of the SL-PRS or a remaining delay budget of the SL-PRS and a remaining time until an SL-PRS transmission duration.

A bandwidth in which an SL-PRS is transmittable may vary depending on the SL grant, and if the bandwidth of the SL grant does not meet a bandwidth required for SL-PRS transmission, a corresponding destination may be excluded.

The transmission UE may determine to transmit an SL-PRS to another UE as well as the selected destination. In this case, information of a physical channel (e.g., a bandwidth, the number of symbols, a combination pattern of the SL-PRS, an SL-PRS resource set, an SL-PRS frequency offset, and a start symbol of the SL-PRS), etc. for configuring the SL-PRS may be stored and then used for a subsequent procedure.

In step 1503, the transmission UE may determine resources for transmitting the SL-PRSs. That is, the number of symbols available for the SL-PRSs in a slot associated with a PSCCH or in the same slot as that for the PSCCH may be determined.

The transmission UE may preferentially allocate SL-PRSs having higher priority to symbols available for SL-PRS transmission. If fewer than all SL-PRS are transmittable (or transmission resources are insufficient), the transmission UE may allocate the resources so that as many SL-PRS as possible are transmittable in the resources regardless of the priority of the SL-PRSs.

Alternatively, the transmission UE may allocate the SL-PRSs to the resources in the order of high priority of the SL-PRSs, or allocate the SL-PRSs to the resources in the order of low remaining delay budgets of the SL-PRSs regardless of priority.

The transmission UE may allocate the SL-PRSs to the resources in the order of high priority, and SL-PRSs having the same priority may be allocated according to UE implementation or allocated to the resources in the order of low remaining delay budgets.

If the transmission UE can no longer allocate any SL-PRS to the resources in the order of high priority (e.g., if there is 1 symbol remaining but a subsequent priority SL-PRS requires 2 symbols), an SL-PRS having highest priority among SL-PRSs using 1 symbol may be allocated to the resources.

In step 1504, the transmission UE may perform SL-PRS transmission. Specifically, an upper layer (e.g., the MAC entity) of the transmission UE may request, from a lower layer (e.g., the PHY layer), SL-PRS transmission and perform the SL-PRS transmission via the PHY layer. In this case, the transmission UE may generate an SL-PRS and add SL transmission information to 1st-stage SCI so as to transmit the SL-PRS to the reception UE. The SL transmission information may include at least one of a source Layer-1 ID, a source Layer-2 ID, a destination Layer-1 ID, a destination Layer-2 ID, a SL process ID, an HARQ process ID, a cast type, HARQ feedback, priority, an SL-PRS bandwidth, the number of SL-PRS symbols, an SL-PRS start symbol, SL-PRS comb N, and an SL-PRS frequency offset.

If SL data transmission information includes multiple pieces of SL-PRS transmission information (e.g., when priorities are different), the transmission UE may determine the SL transmission information by using higher priority among priorities of SL-PRSs to be transmitted, or may store the priorities of the multiple SL-PRSs, respectively, and transmit the same to the PHY layer. The transmission UE may identify whether to transmit the SL-PRS, based on whether priority of the SL-PRS is greater than priority of UL or other SL transmission. If the SL-PRS is transmittable, the transmission UE may indicate the PHY layer to transmit SCI according to the SL grant along with the SL transmission information, and may indicate generation of SL-PRS transmission according to the stored SL grant so as to transmit the SL-PRS to another UE.

The transmission UE may transmit information of a physical channel (a bandwidth, comb N, symbol size M, SL-PRS priority, an SL-PRS frequency offset, an SL-PRS start symbol, and an SL-PRS resource set ID) for configuring the SL-PRS so that the PHY layer may use the same when generating a signal. The information of the physical channel for configuring the SL-PRS may be pre-configured by the base station via RRC, SIB, and pre-configuration, and each piece of information may be mapped to an ID. For example, a specific ID may indicate at least one of a bandwidth, comb N, symbol M, an SL-PRS frequency offset, and an SL-PRS start symbol associated with the ID. Alternatively, the transmission UE may transmit request information associated with a specific destination and service to the base station in advance via an RRC message, etc., and the base station may provide an available SL-PRS resource set and a mapping ID, based on the request information.

Methods described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. A separate storage device on the communication network may access a portable electronic device.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the unit refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more central processing units (CPUs) within a device or a security multimedia card. The unit in embodiments may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal for sidelink (SL) communication, the method comprising:
receiving, from a base station, an SL grant for SL transmission;
in case that there is an SL-positioning reference signal (SL-PRS) for transmission for a selected destination, identifying a first transport block size (TBS) including the SL-PRS based on the SL grant; and
in case that all data within a logical channel with higher priority than a logical channel of the SL-PRS is allocated with resources of the SL grant, transmitting the SL-PRS based on the SL grant.

2. The method of claim 1, further comprising:
in case that all data within the logical channel with higher priority than the logical channel of the SL-PRS is not allocated with resources of the SL grant, identifying that the SL-PRS is not transmitted based on the SL grant, and
identifying a second TBS with no SL-PRS.

3. The method of claim 2,
wherein the second TBS is identified based on a resource element allocated based on the SL grant and a modulation and coding scheme.

4. The method of claim 1,
wherein the first TBS is determined based on resources excluding a symbol used for the SL-PRS.

5. The method of claim 1, further comprising:
selecting the destination; and
selecting a logical channel for transmission for the destination.

6. The method of claim 5,
wherein the selected logical channel includes a logical channel with SL data or a logical channel enabled for hybrid automatic repeat request feedback.

7. A terminal for sidelink (SL) communication, the terminal comprising:
a transceiver; and
a controller coupled with the transceiver and configured to:
receive, from a base station, an SL grant for SL transmission,
in case that there is an SL positioning reference signal (SL-PRS) for transmission for a selected destination, identify a first transport block size (TBS) including the SL-PRS based on the SL grant, and
in case that all data within a logical channel with higher priority than a logical channel of the SL-PRS is allocated with resources of the SL grant, transmit the SL-PRS based on the SL grant.

8. The terminal of claim 7, wherein the controller is further configured to:
in case that all data within the logical channel with higher priority than the logical channel of the SL-PRS is not allocated with resources of the SL grant, identify that the SL-PRS is not transmitted based on the SL grant, and
identify a second TBS with no SL-PRS.

9. The terminal of claim 8,
wherein the second TBS is identified based on a resource element allocated based on the SL grant and modulation and coding scheme.

10. The terminal of claim 7,
wherein the first TBS is determined based on resources excluding a symbol used for the SL-PRS.

11. The terminal of claim 7, wherein the controller is further configured to:
select the destination, and
select a logical channel for transmission for the destination.

12. The terminal of claim 11,
wherein the selected logical channel includes a logical channel with SL data or a logical channel enabled for hybrid automatic repeat request feedback.
